(19) United States
(12) Patent Application Publication
(10) Pub. No.: US 2018/0121606 A1
(43) Pub. Date: May 3, 2018

(54) Cognitive Medication Reconciliation

(71) Applicant: International Business Machines Corporation, Armonk, NY (US)

(72) Inventors: Corville O. Allen, Morrisville, NC (US); Timothy A. Bishop, Minneapolis, MN (US); Albert A. Chung, Cary, NC (US); Elizabeth A. Schreiber, Cary, NC (US)

(21) Appl. No.: 15/340,003

(22) Filed: Nov. 1, 2016

(51) Int. Cl. G06F 19/00

(52) U.S. Cl. CPC G06F 19/322; G06F 19/326; G06F 19/345

(57) ABSTRACT

Mechanisms are provided for evaluating the validity of duplicate medication instances in aggregate patient data. The mechanisms generate aggregate patient data from patient data obtained from computing devices associated with a plurality of different sources of patient data for a patient. The mechanisms analyze the aggregate patient data to identify a duplicate medication instance. The mechanisms determine whether the duplicate medication instance is a valid duplicate medication instance or an invalid duplicate medication instance based on features extracted from the aggregate patient data. The mechanisms, in response to a determination that the duplicate medication instance is an invalid duplicate medication instance, further send a notification to a computing device indicating invalidity of the duplicate medication instance.

### BACKGROUND

The present application relates generally to an improved data processing apparatus and method and more specifically to mechanisms for providing cognitive medication reconciliation for use with cognitive systems, such as decision support systems.

Decision support systems exist in many different industries where human experts require assistance in retrieving and analyzing information. An example that will be used throughout this application is a diagnosis system employed in the healthcare industry. Diagnosis systems can be classified into systems that use structured knowledge, systems that use unstructured knowledge, and systems that use clinical decision formulas, rules, trees, or algorithms. The earliest diagnosis systems used structured knowledge or classical, manually constructed knowledge bases. The Internist-I system developed in the 1970s uses disease-finding relations and disease-disease relations. The MYCIN system for diagnosing infectious diseases, also developed in the 1970s, uses structured knowledge in the form of production rules, stating that if certain facts are true, then one can conclude certain other facts with a given certainty factor. DXplain, developed starting in the 1980s, uses structured knowledge similar to that of Internist-I, but adds a hierarchical lexicon of findings.

Iliad, developed starting in the 1990s, adds more sophisticated probabilistic reasoning where each disease has an associated a priori probability of the disease (in the population for which Iliad was designed), and a list of findings along with the fraction of patients with the disease who have the finding (sensitivity), and the fraction of patients without the disease who have the finding (1-specificity).

In 2000, diagnosis systems using unstructured knowledge started to appear. These systems use some structuring of knowledge such as, for example, entities such as findings and disorders being tagged in documents to facilitate retrieval. ISABEL, for example, uses Autonomy information retrieval software and a database of medical textbooks to retrieve appropriate diagnoses given input findings. Autonomy Auminence uses the Autonomy technology to retrieve diagnoses given findings and organizes the diagnoses by body system. First CONSULT allows one to search a large collection of medical books, journals, and guidelines by chief complaints and age group to arrive at possible diagnoses. PEPID DDX is a diagnosis generator based on PEPID's independent clinical content.

Clinical decision rules have been developed for a number of medical disorders, and computer systems have been developed to help practitioners and patients apply these rules. The Acute Cardiac Ischemia Time-Insensitive Predictive Instrument (ACI-TIPI) takes clinical and ECG features as input and produces probability of acute cardiac ischemia as output to assist with triage of patients with chest pain or other symptoms suggestive of acute cardiac ischemia. ACI-TIPI is incorporated into many commercial heart monitors/defibrillators. The CaseWalker system uses a four-item questionnaire to diagnose major depressive disorder. The PKC Advisor provides guidance on 98 patient problems such as abdominal pain and vomiting.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to be specifically configured to execute the operations of the method in the data processing system. The method comprises generating, by the data processing system, aggregate patient data from patient data obtained from computing devices associated with a plurality of different sources of patient data for a patient. The method further comprises analyzing, by the data processing system, the aggregate patient data to identify a duplicate medication instance indicated by content of the aggregate patient data. The duplicate medication instance is a first entry in the aggregate patient data obtained from patient data originating from a first source that identifies a same or similar medication as a second entry in the aggregate patient data obtained from patient data originating from a second source. The method also comprises determining, by the data processing system, whether the duplicate medication instance is a valid duplicate medication instance or an invalid duplicate medication instance based on features extracted from the aggregate patient data. Moreover, the method comprises, in response to a determination that the duplicate medication instance is an invalid duplicate medication instance, sending a notification to a computing device indicating invalidity of the duplicate medication instance.

In other illustrative embodiments, a computer program product comprising a computer usable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive healthcare system and patient information aggregation system in a computer network;

FIG. 2 is a block diagram of an example data processing system in which aspects of the illustrative embodiments are implemented;

FIG. 3 is an example diagram illustrating an interaction of elements of a healthcare cognitive system and patient information aggregation system in accordance with one illustrative embodiment;

FIG. 4 illustrates a cognitive healthcare system implementing a Question and Answer (QA) or request processing pipeline for processing an input question or request in accordance with one illustrative embodiment;

FIG. 5 is a flowchart outlining an example operation for performing medication reconciliation in accordance with one illustrative embodiment; and

FIG. 6 is a flowchart outlining an example operation for identifying valid and/or invalid duplicate medications in a patient's medical data or information in accordance with one illustrative embodiment.

### DETAILED DESCRIPTION

The strengths of current cognitive systems, such as current medical diagnosis, patient health management, patient treatment recommendation systems, law enforcement investigation systems, and other decision support systems, are that they can provide insights that improve the decision making performed by human beings. For example, in the medical context, such cognitive systems may improve medical practitioners' diagnostic hypotheses, can help medical practitioners avoid missing important diagnoses, and can assist medical practitioners with determining appropriate treatments for specific medical conditions. However, current systems still suffer from significant drawbacks which should be addressed in order to make such systems more accurate and usable for a variety of applications, as well as more representative of the way in which human beings make decisions, such as diagnosing and treating patients. In particular, one drawback of current systems is with regard to the reconciliation of medication information for a patient to ensure that the patient is taking their correctly prescribed medications and are not subjected to potentially dangerous combinations of mediations, over prescribed medication, or otherwise taking medications for which medical conditions of the patient are contraindications.

Typically a single institution (e.g., hospital, medical lab, doctor office, pharmacy, etc.) has a patient's electronic medical record (EMR) which typically only covers the patient information pertinent to that institution, i.e. information about the patient's medical condition, diagnosis, and treatment as provided by that institution. Thus, the institution's EMR for the patient includes only medication prescriptions provided by that institution or medical professionals at that institution. As a result, unless informed by the patient themselves of other medications, treatments, diagnoses, and results of analysis of the patient's medical condition at other institutions or by other medical professionals, one institution or medical professional may be uninformed of other institutions or medical professionals and the corresponding EMRs generated by such. This is problematic in that vital information for treating a patient is left to the patient themselves to provide.

Recent trends, highly influenced by governmental regulations, are to collect patient information from a variety of sources into Health Information Exchanges (HIEs). HIE systems provide facilities for the mobilization of health care information electronically across organizations within a region, community, or system of medical facilities. An HIE system provides the capability to electronically move clinical information among different health care information systems (computing systems) with the goal being able to facilitate access to, and retrieval of, clinical data. By providing a centralized repository of such health information for a patient, the goal is to provide safer and more timely, efficient, effective, and equitable patient-centered care.

HIE systems facilitate the efforts of physicians and clinicians to meet high standards of patient care through electronic participation in a patient's continuity of care with multiple providers. Secondary health care provider benefits include reduced expenses associated with: (1) the manual printing, scanning and faxing of documents, including paper and ink costs, as well as the maintenance of associated office machinery, (2) the physical mailing of patient charts and records, and phone communication to verify delivery of traditional communications, referrals, and test results, and (3) the time and effort involved in recovering missing patient information, including any duplicate tests required to recover such information.

In the United States of America, federal and state regulations regarding HIEs and health information technology (HIT) are still being defined. Federal regulations and incentive programs such as “Meaningful Use”, which is formally known as the Electronic Health Record (EHR) Incentive Program, are rapidly changing the face of this relatively new industry. In addition to changes driven by federal activities, the lessons learned in the ongoing implementation of some state-sponsored HIEs (such as the North Carolina HIE), and the fluctuating nature of health care regulations at the level of the state governments themselves, are leading to additional refinement.

Thus, HIE systems pull a patient's information, e.g., electronic medical records (EMRs), also referred to as electronic health records (EHRs) or patient medical data herein, from multiple health provider information systems (computing systems) that represent the entire patient EMR across multiple institutions. For example, a patient may have EMRs generated by their principal care physician (PCP) based on routine visits that the patient makes to the PCP to obtain care for general medical conditions. The patient may also have EMRs generated by a specialist, such as a podiatrist or ear-nose-throat (ENT) specialist, for treatment sought for specific medical conditions best treated by such a specialist. Still further, the patient may have EMRs for emergency room visits due to injuries sustained, such as in a car accident or other event. Moreover, the patient may have laboratory results generated from a medical lab in support of treatments by another doctor. Furthermore, the patient may have records generated by their pharmacy indicating the medications that the pharmacy has fulfilled for the patient, referred to herein as dispense information or data. All of this information may be combined into a set of EMRs or data structures that give an overall picture of the patient's medical condition and treatments of the medical condition via the HIE system.

HIEs generally serve as a collection system to collect patient medical data or information from the variety of health provider information systems, or computing systems, and do not provide a cognitive system capability for handling such patient information. This collection of patient medical information, or patient medical data, from disparate computing systems leads to many opportunities to improve the care being provided to patients, one opportunity being the ability to reconcile which medications a patient is truly taking, and should be taking, so as to improve the quality of care provided to the patient and inform health providers of the medication status of the patient so that informed decisions may be made.

That is, since a patient may seek services from a variety of different health service providers (or simply “health providers”), each of these health providers may not have a complete picture of the patient's health or know the results of the evaluation of a patient's health, the diagnoses of the patient, and the medications prescribed to the patient by the various other health providers from which the patient may have sought services. For example, the patient may have sought assistance from a specialist at a first medical facility and be prescribed medication A, while the patient may also have sought medical services from another physician for a different medical condition and be prescribed medication B. The physician may not have known the results of the patient's visit with the specialist and vice versa such that the prescribing of medications may not be based on an awareness of the medical condition, diagnosis, and other medications the patient is prescribed and potentially taking. Currently, health providers rely on the patient to provide accurate information in person, through hand written documentation (such as a questionnaire administered when at the health provider location), or verbally when speaking with the health provider. Sometimes, this information is not complete or is not accurate due to human error or even a desire by the patient to withhold some information for various reasons.

Through cognitive logic applied to collections of patient medical data or information from a variety of different sources, the illustrative embodiments provide the ability to correlate medication information from the various sources and analyze that information in a variety of different ways to provide complex cognitive results that more fully inform health providers of the medication status of the patient. In one aspect, the illustrative embodiments address the problems associated with awareness of medication prescriptions and fulfillment of such prescriptions by correlating medication information from these various different sources, identifying contraindications, incompatibilities, duplication, interactions, and other information indicative of a current or potential health condition of the patient due to the medications they may currently be taking.

Another issue addressed by the mechanisms of the illustrative embodiments is to handle prescriptions for medication that a patient has in their patient medical data, but which the patient has stopped taking for various reasons or has completed, but the medication is still listed in the patient's medical data as being actively taken by the patient. Through correlation of medication information from a variety of different sources, as well as the application of cognitive logic mechanisms in accordance with the illustrative embodiments, instances of medications that may no longer be actively taken by the patient may be identified and corresponding notifications sent to health provider to assist in performing health care decision making.

As noted above, one major issue with the distributed care of patients by various health providers is identifying and dealing with contraindications and warnings for when a situation is present with a duplicate medication, or harmful interactions between medications, which would, if known to the health provider, would encourage the health provider to remove a drug from the patient's medication list. The same pharmaceutical class of medication may also be incorrectly given, depending on the dose or the type of medication. These situations are also identified and corresponding cognitive analysis is performed to handle these situations using the mechanisms of the illustrative embodiments.

In general, there is a need for a cognitive system to assist and define which medications should be reconciled and why, making it easier for the physicians to make decisions and see why a medicine should be stopped/removed from a patient's treatment regimen. The illustrative embodiments provide mechanisms for evaluating the patient medical data, e.g. patient EMRs, obtained from a variety of different sources (e.g., institutions such as medical labs, hospitals, doctor's offices, pharmacies, insurance companies, or other medical service/product providers) with regard to medication information (also referred to herein as drug information) to determine if there are duplicate medications or drugs being prescribed, whether certain medications or drugs are contraindicated based on a patient's medical condition as indicated in the patient EMR data from other sources than the one that prescribed the medication/drug, and whether medications/drugs are prescribed that have potential harmful interactions. This evaluation may further involve analyzing patient medical data of cohorts of similar patients with similar medical conditions to determine whether the current patient in question is on a particular medication/drug, should be on a particular medication/drug, or the medication/drug is contraindicated by patient medical data, and in particular medication related content of patient medical data, for other similar patients.

All of the various factors, for a particular medication in an aggregated medication listing, as may be represented in an aggregate medication listing data structure associated with the patient aggregated from medication related content of the patient medical data obtained from the various sources, are weighted and combined to generate a score that indicates whether the particular medication/drug should be removed from the patient's aggregate medication listing data structure, and prescriptions potentially canceled. Corresponding notifications may be generated and sent to the health provider(s) providing health services to the patient. The notification may provide options for the health provider(s) to confirm/deny a modification to the patient's medical data, such as with regard to the aggregate medication listing data structure for the patient, e.g., confirm/deny removal of a medication/drug, confirm/deny a modification to a dosage or other instructions for taking a medication/drug, or the like.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms for providing cognitive medication reconciliation for use with cognitive systems, such as decision support systems. The illustrative embodiments are particularly useful with data processing systems which compile or aggregate patient medical data or information about a patient from a variety of different sources such that cognitive analysis of the compiled information may be performed to reconcile medication information.

That is, with the mechanisms of the illustrative embodiments, a patient information collection system, such as a Health Information Exchange (HIE) or the like, receives, for a particular patient, electronic medical record (EMR) data (also referred to as patient information, patient medical information, or patient medical data) for the patient from a variety of different source computing or information handling systems associated with health service or product providers (referred to collectively as “health providers”). Cognitive logic of a cognitive system in accordance with the illustrative embodiments provide logic for implementing a medication analysis engine that analyzes the aggregate of a patient's medical data (which will be assumed hereafter to be provided in the form of patient EMRs) to deduce whether a medication or drug that is prescribed to the patient should be removed from the patient's aggregate medication listing data structure. Removal of the medication or drug may be appropriate if the medication/drug is a duplicate in the aggregate patient EMR data, has a harmful interaction with other medications/drugs, or should be contraindicated based on the patient's condition, for example. Because the EMR data is from various sources, and these sources tend to only maintain information about their own medical services/products that they have offered to the patient, they may not be cognizant of what other medical service/product providers have prescribed for the patient and thus, such duplicates, harmful interactions, and contraindications may exist in the aggregate EMR data.

In one embodiment, the aggregate EMR data is analyzed by the mechanisms of the illustrative embodiments to identify instances of prescriptions for medications/drugs (hereafter referred to collectively as “medications”) in the EMR data. For each such medication, a set of sources (institutions) that prescribed the medication, the medical personnel (e.g., physician) responsible for the prescription, and the like, are identified to thereby identify a specific source of an instance of the medication prescription. The mechanisms then check whether a similar class of medication or intended treatment from the medication is also in the patient's medication list from another source (e.g. combination of institution, personnel, etc.). Depending on the proximity of the dates for the medication prescriptions, the type of institution (ER, Ambulatory, Clinic, Hospital, Pharmacy), geographic location of the institution relative to other institutions prescribing the medication and/or locations personal to the patient (home, work, etc.), the likelihood that the medication prescription is a duplicate is given a weighted score.

For example, the same class of medication from two different institution types within a short duration of time of each other, is indicative of the medication being duplicative, and potentially prescribed for emergency or quick visits. To the contrary, with a follow up from a primary care physician (PCP), location will be similar, institution will be similar, and duration of time between prescriptions will be larger and may coincide with a previous prescription expiration time. This is indicative of the subsequent prescription being a renewal or additional prescription to supplement the previous prescription and is not in fact a duplicate medication prescription.

Analyzing filled prescription information from a pharmacy or other provider of medications, is used to note the location the prescription was filled, the date filled, and any refills, and the amount of dosage and times to complete taking the medication (e.g. a standard medication pack lasts for 10 calendar days; a prescription for the medication is to be taken once daily, and the prescription providing 30 pills indicates the completion date to be 30 days from the date the prescription was filled). Based on this information cross-referenced against prescription entries in the patient's aggregated EMR information, a medication is given a weighted score towards its usage having being completed, i.e. a weighted score as to whether the patient has already completed the prescribed treatment using the medication or not prior to, or at the same time, that another prescription for the medication, or a medication of the same class, was made.

Moreover, given a cohort set for patients with similar medical maladies, medical information, such as lab results, may be correlated with medications prescribed to similar patients to thereby determine whether a given patient is taking a medication even though the patient EMR data may not indicate such, whether the patient should be on the particular medication, or there are contraindications for prescribing the medication. This information provides a score indicative of whether a medication should be removed from a patient's medication listing due to contraindications.

Further, based on the medication interactions, a medication is scored as to whether it should be removed based on the medications that are in the patient's medication list. The medication interactions may be evaluated based on pre-defined data structures indicating medication interactions, medication interaction information extracted from natural language content of natural language documentation, or the like.

The scores may be individually evaluated or evaluated in the aggregate to determine whether a medication should be removed from a particular patient's medication listing. For example, if any of the different scores are sufficiently high to warrant removal of the medication, then the medication is removed from the medication listing for the patient. Alternatively, a weighted aggregation of the scores may be used and compared to a threshold to determine whether the medication should be removed. Appropriate notifications indicating recommendations for removal of the medication from the medication listing may be sent to the patient's medical providers which may then make the final determination as to whether to remove the medication or not, and thereby invalidate the currently active prescription for the medication. User interface elements may be provided for allowing the medical provider to respond to the notification to either confirm or deny removal of the medication from the medication listing. Alternatively, or in addition, if the score is sufficiently above the threshold, then removal may be automatically performed.

It should be appreciated that there are a variety of different elements of a patient's aggregate medical data or aggregate EMR data that may be correlated and compared by the mechanisms of the illustrative embodiments to evaluate the medications in a patient's aggregate medication listing data structure so as to reconcile these instances of medications found in the aggregate EMR data. These various elements, some of which are summarized above and further described hereafter, are generally referred to as medication related data types. The medication related data types may have different values depending on the particular information being conveyed by the data type. For example, a data type may be “medication type” with a corresponding value of “anti-inflammatory” or “pain reliever”. Another data type may be “date of service” which a corresponding value being a date on which a particular service was provided. Other data types may be “institution” with values being “pharmacy”, “hospital,” “primary care physician”, or the like. Various data types may be used to represent various types of patient medical information in the aggregate patient medical data or aggregate EMR data and each data type may have different values depending on the particular entry in the patient medical data or EMR. Correlation and comparison mechanisms of the illustrative embodiments may be utilized to correlate this information and compare this information to identify potential conflicts in medication information in the aggregate patient data, or aggregate EMR data, which may then be used as a basis for making decisions regarding the aggregate medication listing data structure for the patient.

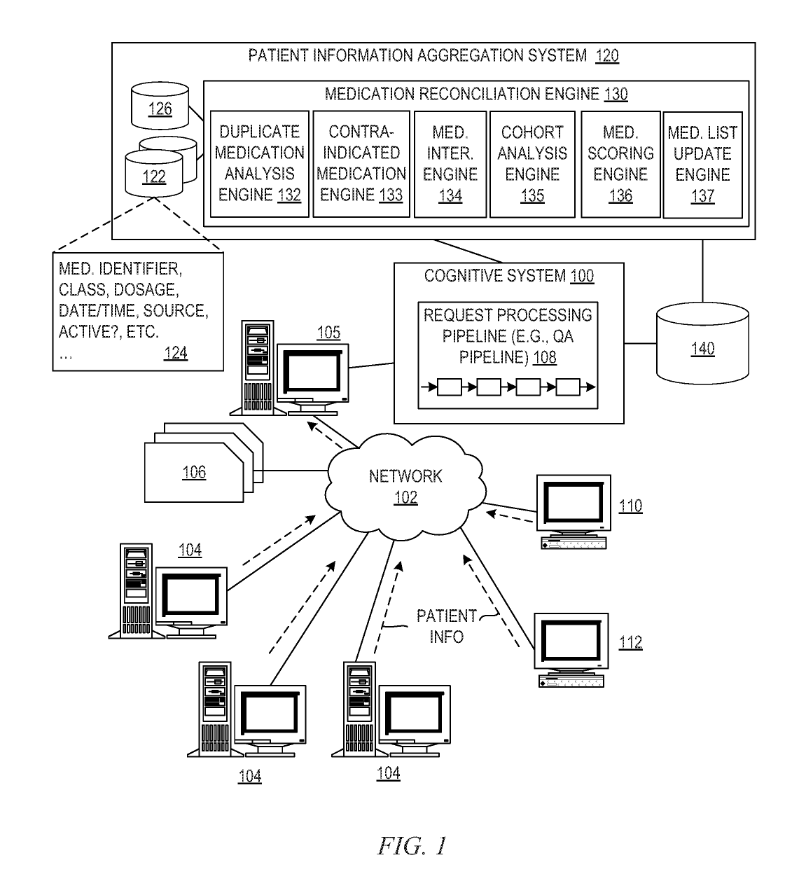

The illustrative embodiments may be utilized in many different types of data processing environments. In order to provide a context for the description of the specific elements and functionality of the illustrative embodiments, FIGS. 1-4 are provided hereafter as example environments in which aspects of the illustrative embodiments may be implemented. It should be appreciated that FIGS. 1-4 are only examples and are not intended to assert or imply any limitation with regard to the environments in which aspects or embodiments of the present invention may be implemented. Many modifications to the depicted environments may be made without departing from the spirit and scope of the present invention.

FIGS. 1-4 are directed to describing an example cognitive system for healthcare applications (also referred to herein as a “healthcare cognitive system”) which implements a request processing pipeline, such as a Question Answering (QA) pipeline (also referred to as a Question/Answer pipeline or Question and Answer pipeline) for example, request processing methodology, and request processing computer program product with which the mechanisms of the illustrative embodiments are implemented. These requests may be provided as structure or unstructured request messages, natural language questions, or any other suitable format for requesting an operation to be performed by the healthcare cognitive system. As described in more detail hereafter, the particular healthcare application that is implemented in the cognitive system of the present invention is a healthcare application for providing healthcare decision support. The healthcare decision support may perform any suitable operation for assisting a medical professional in treating the patient. For example, the healthcare decision support system may assist with evaluating a medical condition of the patient, diagnosing the patient, providing treatment recommendations, or simply viewing the aggregate patient information obtained from a variety of different sources, where such aggregated patient information may be analyzed in accordance with the illustrative embodiments to reconcile medication information in the patient information.

It should be appreciated that the healthcare cognitive system, while shown as having a single request processing pipeline in the examples hereafter, may in fact have multiple request processing pipelines. Each request processing pipeline may be separately trained and/or configured to process requests associated with different domains or be configured to perform the same or different analysis on input requests (or questions in implementations using a QA pipeline), depending on the desired implementation. For example, in some cases, a first request processing pipeline may be trained to operate on input requests directed to a first medical malady domain (e.g., various types of blood diseases) while another request processing pipeline may be trained to answer input requests in another medical malady domain (e.g., various types of cancers). In other cases, for example, the request processing pipelines may be configured to provide different types of cognitive functions or support different types of healthcare applications, such as one request processing pipeline being used for patient diagnosis, another request processing pipeline being configured for medical treatment recommendation, another request processing pipeline being configured for patient monitoring, etc.

Moreover, each request processing pipeline may have their own associated corpus or corpora that they ingest and operate on, e.g., one corpus for blood disease domain documents and another corpus for cancer diagnostics domain related documents in the above examples. In some cases, the request processing pipelines may each operate on the same domain of input questions but may have different configurations, e.g., different annotators or differently trained annotators, such that different analysis and potential answers are generated. The healthcare cognitive system may provide additional logic for routing input questions to the appropriate request processing pipeline, such as based on a determined domain of the input request, combining and evaluating final results generated by the processing performed by multiple request processing pipelines, and other control and interaction logic that facilitates the utilization of multiple request processing pipelines.

As noted above, one type of request processing pipeline with which the mechanisms of the illustrative embodiments may be utilized is a Question Answering (QA) pipeline. The description of example embodiments of the present invention hereafter will utilize a QA pipeline as an example of a request processing pipeline that may be augmented to include mechanisms in accordance with one or more illustrative embodiments. It should be appreciated that while the present invention will be described in the context of the cognitive system implementing one or more QA pipelines that operate on an input question, the illustrative embodiments are not limited to such. Rather, the mechanisms of the illustrative embodiments may operate on requests that are not posed as “questions” but are formatted as requests for the cognitive system to perform cognitive operations on a specified set of input data using the associated corpus or corpora and the specific configuration information used to configure the cognitive system. For example, rather than asking a natural language question of “What diagnosis applies to patient P?”, the cognitive system may instead receive a request of “generate diagnosis for patient P,” or the like. It should be appreciated that the mechanisms of the QA system pipeline may operate on requests in a similar manner to that of input natural language questions with minor modifications. In fact, in some cases, a request may be converted to a natural language question for processing by the QA system pipelines if desired for the particular implementation.

As will be discussed in greater detail hereafter, the illustrative embodiments may be integrated in, augment, and extend the functionality of these QA pipeline, or request processing pipeline, mechanisms of a healthcare cognitive system with regard to performing cognitive medication reconciliation based on aggregate patient information aggregated from a variety of different patient information sources. The mechanisms of the illustrative embodiments may operate on aggregate patient information which may be used as a basis for performing cognitive healthcare operations. For example, the mechanisms of the illustrative embodiments may process the aggregate patient information to reconcile medication information in the aggregate patient information and then provide the reconciled medication information as part of the patient information upon which the cognitive healthcare operations are performed. Such reconciled medication information may comprise modifications to originally present medication information which is modified based on the reconciliation recommendations generated and the responses by appropriate medical professionals to implement such modifications.

With regard to the cognitive healthcare operations, the cognitive healthcare system performing such operations may be implemented with a Question and Answer (QA) system and pipeline, a request pipeline, or the like, as previously noted above. As such, it is important to have an understanding of how cognitive systems and question and answer creation in a cognitive system implementing a QA pipeline is implemented before describing how the mechanisms of the illustrative embodiments are integrated in and augment such cognitive systems and request processing pipeline, or QA pipeline, mechanisms. It should be appreciated that the mechanisms described in FIGS. 1-4 are only examples and are not intended to state or imply any limitation with regard to the type of cognitive system mechanisms with which the illustrative embodiments are implemented. Many modifications to the example cognitive system shown in FIGS. 1-4 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information usable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The cognitive system 100 is implemented on one or more computing devices 105 (comprising one or more processors and one or more memories, and potentially any other computing device elements generally known in the art including buses, storage devices, communication interfaces, and the like) connected to the computer network 102. The network 102 includes multiple computing devices 104, 105, 110, and 112 in communication with each other and with other devices or components via one or more wired and/or wireless data communication links, where each communication link comprises one or more of wires, routers, switches, transmitters, receivers, or the like. The cognitive system 100 and network 102 enables question processing and answer generation (QA) functionality for one or more cognitive system users via their respective computing devices 110-112. Other embodiments of the cognitive system 100 may be used with components, systems, sub-systems, and/or devices other than those that are depicted herein.

The cognitive system 100 is configured to implement a QA pipeline 108 that receive inputs from various sources. For example, the cognitive system 100 receives input from the network 102, a corpus of electronic documents 106, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 106 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 106. In one embodiment, the questions are formed using natural language. The cognitive system 100 parses and interprets the question via a request or QA pipeline 108, and provides a response to the cognitive system user, e.g., cognitive system user 110, containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

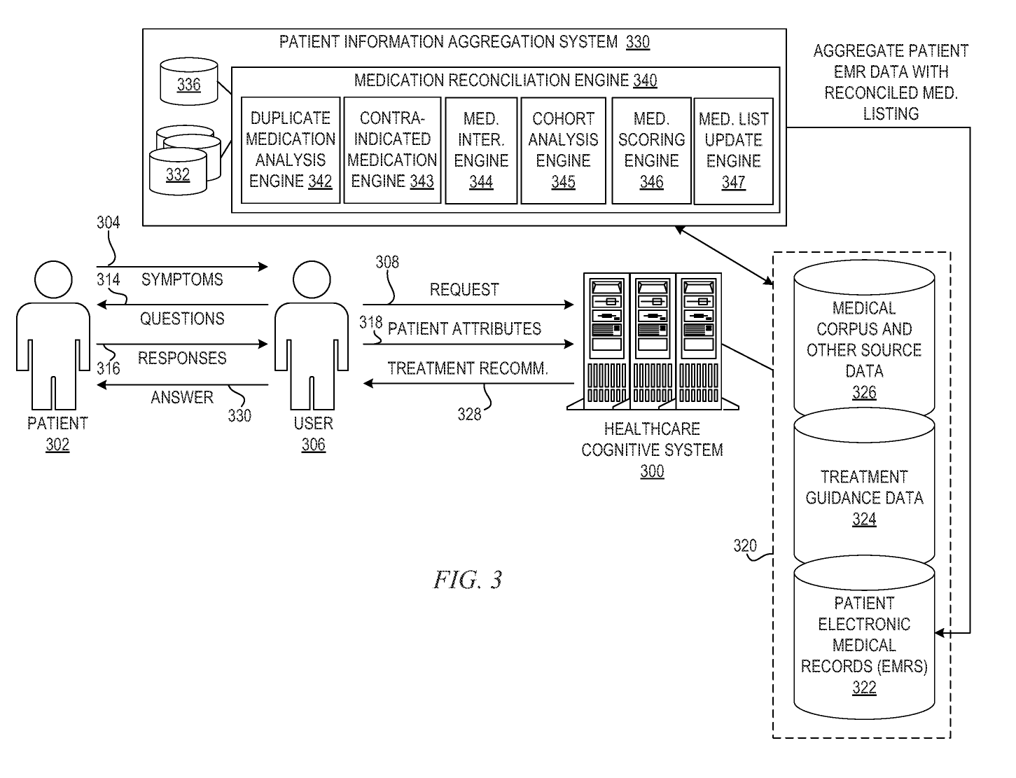

The cognitive system 100 implements the request or QA pipeline 108 which comprises a plurality of stages for processing an input question or request and the corpus of data 106. The QA pipeline 108 generates answers for the input question, or results for a request, based on the processing of the input question and the corpus of data 106. The QA pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question which it then parses to extract the major features of the question, which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms.

The scores obtained from the various reasoning algorithms are then weighted against a statistical model that summarizes a level of confidence that the QA pipeline of the IBM Watson™ cognitive system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, cognitive system 100 may provide a cognitive functionality for assisting with healthcare based operations. For example, depending upon the particular implementation, the healthcare based operations may comprise patient diagnostics, medical treatment recommendation systems, medical practice management systems, personal patient care plan generation and monitoring, patient electronic medical record (EMR) evaluation for various purposes, such as for identifying patients that are suitable for a medical trial or a particular type of medical treatment, or the like. Thus, the cognitive system 100 may be a healthcare cognitive system 100 that operates in the medical or healthcare type domains and which may process requests for such healthcare operations via the request processing pipeline 108 input as either structured or unstructured requests, natural language input questions, or the like. In one illustrative embodiment, the cognitive system 100 is a healthcare based decision support system that may operate to perform one or more of analysis of a patient's medical condition, diagnosis of a patient, treatment recommendation generation and/or evaluation for a patient based on the patient's personal patient information, or the like.

As shown in FIG. 1, the cognitive system 100 mechanisms of the illustrative embodiments are further augmented to include logic implemented in specialized hardware, software executed on hardware, or any combination of specialized hardware and software executed on hardware, for implementing a medication reconciliation engine 130 which operates in conjunction with the cognitive system 100. Although shown in FIG. 1 as separate from the cognitive system 100 for purposes of illustration, the illustrative embodiments are not limited to such a configuration. To the contrary, the medication reconciliation engine 130, or portions of the medication reconciliation engine 130, may be integrated in the cognitive system 100 without departing from the spirit and scope of the present invention.

In the depicted example of FIG. 1, the medication reconciliation engine 130 is implemented as part of, or in conjunction with, a patient information aggregation system 120. The patient information aggregation system 120 operates to aggregate patient data or information, such as electronic medical records (EMRs), from a variety of different sources of patient information, such as different health provider computing systems or information handling systems. In some illustrative embodiments, the patient information aggregation system 120 is a health information exchange (HIE) or other centralized repository of patient information that retrieves or otherwise receives patient information from a variety of health provider computing systems and combines it into data structures associated with the corresponding patients, thereby providing an aggregation of patient information for the patient. For example, the patient information aggregation system 120 collects patient information from a variety of medical facility computing systems, e.g. computing systems associated with hospitals, doctor offices, medical laboratories, emergency care facilities, medical insurance companies, pharmacies, and the like.

The information obtained from each of these sources is correlated, such as based on patient name or unique patient identifier, such that an aggregate patient registry is generated having, for each patient in a plurality of patients, one or more data structures comprising the patient information aggregated from the variety of sources. The patient information aggregation system 120 may provide this patient registry as a database or set of data structures 140 for use by the cognitive system 100 in performing its cognitive operations. As part of the generation of or maintenance of the patient registry 140, the patient information aggregation system 120 may utilize medication reconciliation engine 130 to reconcile medication information obtained from the variety of different sources. The operation of the medication reconciliation engine 130 may be performed dynamically as new updates to the patient registry 140 are performed, such that as new patient information is received by the patient information aggregation system 120 for inclusion in a patient's data structures in the patient registry 140, the new patient information is processed along with the existing patient information in the patient registry 140 to reconcile any medications indicated in the new patient information.

The patient information aggregation system 120 comprises resources data structures 122 which store data, such as configuration data and reference data, which may be used by the patient information aggregation system 120 to perform its operations. The resources data structures 122 may also provide a temporary storage for data generated by the patient information aggregation system 120. In particular, the resources data structures 122 may store medication information reference documents or data structures that indicate the details of a variety of different medications with regard to their class, their interactions with other medications, their side effects, warnings or medical conditions that are contraindications for use of the medication, and the like. Such reference information may be obtained from natural language processing of documentation, manually provided through subject matter expert input, or the like. For example, such data regarding medications is widely available via a variety of sources from the pharmaceutical companies that provide such medications, medical organizations, governmental web sites, and the like, and may be compiled into one or more data structures representing the detailed information of a medication. It should be appreciated that while the above description assumes that such information is part of the resources data structure 122 of the patient information aggregation engine 120, this resource information may be stored elsewhere, such as in the medication reconciliation engine 130, and made available to the patient information aggregation system 120 and/or medication reconciliation engine 130 for use in performing their operations.

The resources data structures 122 may also comprise other data operated on or otherwise utilized by, or generated by, the patient information aggregation system 120. For example, the resources data structures 122 may store patient cohort data structures which identify cohorts of patients having similar characteristics. That is, the patient information aggregation system 130, as part of its aggregation of patient information into individual collections of patient information for a plurality of patients, may identify commonalities between patients and one or more defined cohorts of patients having common characteristics through a comparison operation. For example, the patient information aggregation system 130 may generate a cohort for Type 2 diabetes patients comprising all of the patients that have been diagnosed with Type 2 diabetes. The cohorts may be specialized to any desired granularity, and there may be sub-cohorts within cohorts. For example, within a Type 2 diabetes cohort, a sub-cohort may be female patients over the age of 40 such that the sub-cohort comprises all of the female patients, over the age of 40, who have been diagnosed with Type 2 diabetes. Of course, these patient cohort data structures may be periodically, or dynamically in response to the input of new patient information, updated. The resources data structures 122 may store data structures that point to the patients that are classified into the various cohorts such that their patient information from the patient registry may be retrieved when needed for processing as being part of the patient cohort, e.g., for processing by the cohort analysis engine 135 as described hereafter.

The resources data structures 122 may also temporarily store medication list data structures 124 for patients as the patient information is being aggregated by the patient information aggregation system 120. The medication list data structures 124 may be generated by the medication reconciliation engine 130 as a temporary data structure for reconciling the medications indicated in patient information from a variety of sources. The medications listing data structure 124 may indicate various information about the medications indicated in the patient information including the names of the medications, the classes, dosage, dates/times of prescription, source of the prescription, whether the medication is being actively taken or not, and other information indicating the details of the prescription of the medication to the patient. This information may be provided as medication data types with associated values, for example. This information may be persisted in the patient registry 140 once medication reconciliation is completed and the patient's attending medical professionals make any changes to the medication list data structure 124 in response to notifications, or medications are removed due to high scores, as discussed hereafter.

The medication reconciliation engine 130 provides logic for generating, for each patient whose patient information is aggregated by the patient information aggregation system 120, a medication listing data structure 124 indicating the medications that have been prescribed to the patient or the patient is taking (such as in the case of “over the counter” medications which do not require a prescription). The medication reconciliation engine 130 comprises logic that parses and analyses the patient information (hereafter assumed to be a patient electronic medical record (EMR)) received from the variety of sources, such as computing systems at various medical facilities, e.g., servers 104 in FIG. 1, and aggregated by the patient information aggregation system 120 into an aggregation of patient information 126, to identify instances of medication information being present in the aggregate patient EMR. In some illustrative embodiments, this parsing and analysis may enlist the logic and functionality of the cognitive system 100 and/or the pipeline 108 to perform natural language processing on the aggregate patient EMR data 126 to identify instances of medications and the corresponding context indicating details of the prescription associated with the instance of the medication. That is, for example, the natural language processing mechanisms of the cognitive system 100 may be configured to identify indicators of medications, such as various data types and their corresponding values including, but not limited to, medication names, unique identifiers, and the like, in the patient EMRs and extract features from the surrounding context indicating terms of the prescription, e.g., dosage information, the attending medical professional that prescribed the medication, the medical facility associated with the prescription, etc.

The medication reconciliation engine 130, and in particular the medication list update engine 137, may utilize the information extracted from the patient EMRs to generate a medication listing data structure 124 for the patient in the resources data structures 122, or otherwise stored by the medication reconciliation engine 130. The medication list data structure 124 may comprise entries, where each entry corresponds to a different medication identified in the patient's EMRs. In generating the medication listing data structure 124, the mediation reconciliation engine 130 reconciles the various instances of medications identified in the patient's EMRs 126 with regard to determining whether instances of medications are duplicative prescriptions, contra-indicated by medical conditions of the patient, interfere or interact with other medications or treatments of the patient, are medications that other patients having similar characteristics are taking, or the like. In addition, the medication reconciliation engine 130 may determine whether other similar patients are taking medications that the current patient does not have listed in their patient EMRs 126 and thus, may need to be considered for adding to the patient's medication listing data structure 124. The medication reconciliation engine 130 comprises various engines 132-137 to perform the analysis of the instances of medications in the patient EMRs 126 aggregated by the patient information aggregation system 120.

The duplicate medication analysis engine 132 comprises logic for determining whether an instance of a medication in the patient's EMRs 126 is a duplicate prescription of the medication or not, and/or whether the medication instance provides a similar effect, or treats a similar medical condition, as another medication being taken by the patient. For each medication in the medication list data structure 124, a set of sources (institutions, medical professional, or the like) that prescribed the medication are identified, as determined from the features, e.g., medication data types and their corresponding values, extracted when parsing and processing the patient information received from the various sources, to thereby identify for each instance a specific source of the instance of the medication prescription, e.g., the institution, medical professional, etc., associated with the computing device, such as a server 104. The duplicate medication analysis engine 132 then performs a check as to whether a similar class of medication, intended treatment from the medication, or medical condition being treated, is also in the patient's medication list data structure 124 from another source, e.g., combination of institution, personnel, etc. (it is noted that different doctors at the same hospital may treat a patient and thus, a source may be a combination of institution and medical personnel).

In order to reconcile medication instances in the aggregate patient EMRs 126 for the patient, the duplicate medication analysis engine 132 may utilize medication resource information as identified in the resource data structures 122. For example, medications are associated with classes of medication, e.g., antibiotics, pain relievers, narcotic pain relievers, blood pressure reduction medicine, antihistamines, decongestants, etc. The classes may be based on the effects of the medication. Medications in a same class may be duplicative of one another and thus, there may be a risk of overprescribing a type of medication to a patient when the patient seeks medical assistance from a plurality of different providers for the same or different medical conditions. This duplicative medication may be with regard to the same medication being prescribed, potentially with the same or different dosages, or different medications that are classified into a same class of medications.

If potential duplicative medications have been prescribed to the patient from different sources, i.e. instances of the same medication are found in the aggregate patient EMR 126 but from different sources, or duplicative medications of a same class are found in the aggregate patient EMR but from different sources, then further analysis is performed to determine whether the instances are in fact incorrect or invalid duplicates or if the multiple instances of medications are likely valid duplications, i.e., there is a good reason for the duplicate instances of the same or similar medications in the patient's aggregate EMR data 126.

In order to determine whether the multiple instances of the same or similar medications are valid duplicates or not, the duplicate medication analysis engine 132 analyzes timing information associated with the instances of the mediations in the patient's aggregate EMR data 126. That is, as one of the features, e.g., data types and corresponding values, extracted from the aggregate patient EMR data 126 when identifying instances of medications, the dates associated with the instances may be extracted along with other features including indications of the source. The source features extracted may be correlated with resource data structure 122 information indicating characteristics of known sources of patient information, such as the geographic location of the source, the type of facility of the source (e.g., Emergency Room, Ambulatory, Clinic, Hospital, Pharmacy, etc.), type of medical practice provided by the source (e.g., a doctor that is a podiatrist, while another doctor's medical practice may be an internal medicine doctor, etc.), and the like. In addition, information in the resources data structures 122, in the aggregate patient EMR data 126, or the like, may provide information about the patient, such as home and work addresses, and the like, that may be relevant for medication reconciliation analysis.

These various features may be weighed relative to one another by the duplicate medication analysis engine 132 to generate a score indicative of whether or not one instance of a medication present in the aggregate patient EMR data 126 is a duplicate of another. As one possible implementation, the duplicate medication analysis engine 132 may determine the proximity of the dates for the instances of medication prescriptions in the aggregate patient EMR data 126, the type of institutions that are the source of the medication prescriptions, geographic location of the institution relative to the other institutions prescribing the medication, or similar medication, and/or relative to locations personal to the patient (home, work, etc.), the likelihood that the medication prescription is a duplicate is given a weighted score. The duplicate medication analysis engine 132 applies logic, such as may be presented in rules or policies implemented by the duplicate medication analysis engine 132, to the set of features associated with the instances of medication prescriptions for the same or similar medications found in the aggregate patient EMR data 126, and generates a weighted score.

For example, the logic or rules may indicate that instances of medication having a same class of medication, prescribed from two different institution types (determined from the institution features of the instances) within a short duration of time of each other (determined from dates associated with the instances), are indicative of the medication being duplicative, and potentially prescribed for emergency or quick visits, e.g., one time use or limited use while at a facility receiving treatment. Further analysis may be performed to determine whether the duplicative prescription is valid or not. In order to verify the duplicate prescription, the location of the source may be compared to other locations of sources of medical services the patient has utilized, the location of the patient's home and work, and the like, to determine if the location of a source of a duplicate medication is relatively near these other locations. This gives insight into whether the patient's duplicate prescription is potentially due to the patient having lost or failed to take with them their original prescription, e.g., the patient is on vacation or a trip away from their home location and failed to bring with them their medication. Moreover, any context information extracted along with the instance of the medication in the aggregate patient EMR data 126 may be analyzed, such as by way of natural language processing, to identify any reasoning for the duplicate prescription instance in the aggregate patient EMR data 126.

Similarly, in a case where there are two instances of the same medication being prescribed, such as due to a follow up visit with the patient's primary care physician (PCP), a location of the source of the instances will be similar, the institution of the source will be similar, and the duration of time between the instances of medication prescriptions will be larger and may coincide with a previous prescription expiration time (another feature that may be extracted from the medication information in the patient EMR data). This is indicative of the subsequent instance of the medication prescription being a renewal or additional prescription to supplement the previous prescription and is not in fact a duplicate medication prescription. Thus, while the medication instances may be duplicative, they are valid duplicates.

On the other hand, a duplicate may be invalid in many different cases, such as in the case where a patient sees two different providers and provider A may prescribe a medication that patient is already taking or that was already prescribed by provider B. With the mechanisms of the illustrative embodiments, both prescriptions made by the providers A and B will be recorded in the patient's EMRs and will be duplicates of each other, i.e. there are two separate records of the same medication, depending on the way in which the particular EMR system stores medication information.

As another example of an invalid duplicate, i.e. a duplicate where the patient should not be taking both medications, consider a scenario in which a patient is taking an “over-the-counter” medication, such as ibuprofen, and a provider prescribes a pain reliever medication which either contains ibuprofen or another NSAID. As yet another example, consider a scenario in which a patient has bene prescribed medications which are combinations of drugs, such as Theraflu and Percocet. Each medication may treat a different medical condition, however both may contain a same or similar ingredient, e.g., in the case of Theraflu and Percocet, both contain acetaminophen. Each of these scenarios represent cases where invalid duplicates may appear in a patient's EMR records.

In addition, the analyzing of filled prescription information from a pharmacy or other provider of medications, is used by the duplicate medication analysis engine 132 to note the location the prescription was filled, the date filled, and any refills, and the amount of dosage and times to complete taking the medication. The information obtained from the aggregate patient EMR data 126 including such filled prescription information from a pharmacy or provider of medication, may be correlated with additional information about the medication which may be present in the resource data structures 122 to obtain a general understanding of the medication, the type or class of the medication, the general way in which the medication is taken, the effects of the medication, the interactions of the medication with other medications, and the like. The combination of resource information about the medication and the actual instances of the medication and their context information in the aggregate patient EMR data 126, a determination may be made as to when the patient should be taking the medication, when the prescription for the medication is to expire, and the like, e.g., a resource information may indicate that for a particular medication, the standard medication pack lasts for 10 calendar days, or for another medication a prescription for the medication is to be taken once daily, and the prescription provides 30 pills, thereby indicating the completion date to be 30 days from the date the prescription was filled). Based on this information cross-referenced against prescription entries in the patient's aggregated EMR information 126, a medication is given a weighted score towards its usage having been completed, i.e. a weighted score as to whether the patient has already completed the prescribed treatment using the medication or not prior to, or at the same time, that another prescription for the medication, or a medication of the same class, was made.

This information, as well as other information in the aggregate patient EMR data 126, such as dates of medication instances relative to a current date, dates of last fulfillment of a prescription relative to the current date, and the like, may be used to determine whether a medication instance in the aggregate patient EMR data 126 is an actively taken medication or is inactive. For example, medication instances in the aggregate patient EMR data 126 that are more than a predetermined period of time older than the current time, and for which no subsequent prescription fulfillment data is present in the aggregate patient EMR data 126, may be determined to be inactive. Similarly, medication instances that are current relative to the current time, but which do not show as having been fulfilled by a pharmacy since prescribed, may be considered inactive. Other medication instances may be considered active. The active/inactive status of a medication instance may be dynamically modified based on additions to the aggregate patient EMR data 126 when the patient fulfills a prescription at a pharmacy that reports such information to the patient information aggregation system 120. Whether or not a medication instance is active/inactive is another factor that may be weighted and scored in combination with other factors to determine whether a medication instance is a duplicate and whether that duplicate is valid/invalid.

Many other factors may be evaluated to determine whether an instance of a medication in the aggregate patient EMR data is a duplicate of another medication, e.g., has a same class of medication, provides a similar treatment or effect, addresses a same or similar medical condition, is known to be a substitute for the other medication, or the like. Having determined that there is a duplicate medication instance present in the aggregate patient EMR data 126, a determination is made based on various factors as to whether the duplicate medication instance in the aggregate patient EMR data 126 is a valid duplicate or invalid duplicate. The determination of whether a duplicate medication instance in the aggregate patient EMR data 126 is valid or not may take many different forms including, but not limited to, determining whether the duplicate is an emergency replacement, vacation replacement, short term or emergency administering of the medication at a medical facility such as in the case of in-patient care, a refill of an expired prescription, or the like. Both with the determination of whether a duplicate is present or not, and the determination as to whether that duplicate is valid or not, a weighted score evaluation may be used to evaluate the various factors contributing to the determination and weighting certain factors more or less heavily based on the particular implementation.

The weighting values applied to these factors indicate a relative strength of the indication of that factor as to whether a duplicate is present or whether the duplicate is valid, for example. For example, a heaviest weight value may be applied to the name of a medication such that if two medication instances use the same name of the medication, then it is determined that the two instances are duplicative. A relatively lower weight value may be given to an evaluation of the relative distance between the location of the patient's home and the source of medication instance, since this is less likely to be indicative of a medication instance being duplicative or not.

The duplicate medication analysis engine 132 generates a determination, for each instance of a medication in the aggregate patient EMR data 126 for a patient, whether that instance of the medication is likely a duplicate of another medication in the aggregate patient EMR data 126 and if so, whether that duplicate is likely a valid or invalid duplicate. The likeliness may be evaluated relative to one or more threshold values indicating a threshold degree of confidence necessary for determining that the medication instance is a duplicate and the duplicate is valid/invalid. For those medication instances having weighted score values meeting the conditions of a predetermined relationship relative to the threshold value, e.g., equal to or greater than, equal to or less than, or the like, a determination may be made that an invalid duplicate medication instance is likely present in the aggregate patient EMR data 126. In response, the medication reconciliation engine 130 may send a notification to the patient and/or a current or primary medical professional treating the patient, or the medical professional that is the source of the duplicative medication instance, to inform them of the potential need to modify the medications prescribed to the patient. The notification may be sent to a computing device associated with the patient/medical professional via the network 102 so as to inform the medical professional of the potentially invalid duplicate medication instance and giving them an interface through which they can confirm/reject the duplicate medication instance as being valid. The response from the medical professional may be received by the medication reconciliation engine 130 and used by the medication list update engine 137 to determine whether to include or remove the duplicate medication instance from the medication list associated with the patient and the aggregate patient EMR data 126 for the patient.

The contra-indicated medication engine 133 provides logic for evaluating each medication instance in the aggregate patient EMR data 126 with regard to whether the current medical condition of the patient contra-indicates the medication as being a correct medication to be administered to the patient. For example, current medication conditions, such as diagnoses, vital signs, and the like, associated with the patient as indicated in the patient information within a predetermined time period of the current time in the aggregate patient EMR data 126, may be compared to warnings, contra-indications, and other information about the medication as determined from the medication resource information in the resource data structures 122. For example, the patient may be prescribed a medication for a medical condition by a first medical professional at a first institution, and that medication may have associated warnings that the medication should not be taken by patients having high blood pressure. If the patient is later diagnosed, by another medical professional at the same or a different institution, with high blood pressure, the medical condition contra-indicates the applicability of the medication to this patient. The second medical professional may not have complete knowledge of the patient's previous prescription of the medication. However, with the mechanisms of the illustrative embodiments, in response to the second medical professional entering the information of the diagnosis of high blood pressure into the patient's EMR which is then sent to the patient information aggregation system 120, the medication reconciliation engine 130 may reconcile the new patient information with the previous medication information for the patient and determine that the contra-indication is present. As a result, a warning notification may be generated and output to the patient and/or the medical professional that is the source of the prescription for the medication.

Thus, if the current medication condition of the patient indicates a contra-indication for an active medication being taken by the patient, as indicated in the aggregate patient EMR data 126, then a corresponding notification may be sent to the source of the medication instance to again verify whether or not the medication should be included in the patient's medication list associated with the aggregate patient EMR data 126. The notification may indicate the contra-indication in the patient's aggregate patient EMR data 126, e.g., the medical condition that causes a contra-indication for the medication prescribed, and request that the medical professional indicate whether or not the medication should be maintained in the patient's medication listing. Based on the response, the medication listing data structure 124 may be updated by the medication listing update engine 137 to include/exclude the medication instance.

Again, as an example, a medical professional at a first medical facility, e.g., the patient's PCP office, may prescribe medication A for a first medical condition of the patient. At some time later, the patient may seek medical assistance at a second medical facility for a second medical condition. The second medical condition may be a contra-indication for medication A, however, the medical professional at the second medical facility may not be aware of the fact that the patient is taking medication A. Thus, the mechanisms of the illustrative embodiments, when reconciling medication instances in the aggregate patient EMR data 126 from both the first and second medical facilities, identifies the contra-indication in the patient information obtained from the second medical facility, with regard to the medication instance in the patient information from the first medical facility, and sends a notification to the medical professional at the first medical facility that prescribed medication A. The notification informs the medical professional of the contra-indication and provides options for continuing to include medication A in the medication listing for the patient or removing it from the medication listing for the patient. As discussed hereafter, removal of a medication from the medication listing data structure 124 may initiate other procedures for invalidating prescriptions and/or sending alerts to ensure that the patient does not continue taking a medication that is removed from the medication listing.

For example, the oral diabetes drug Metformin is contraindicated in patients with renal failure or renal impairment. Thus, one can visualize a scenario in which a patient who is on the drug Metformin, but later develops renal failure, may encounter a situation as noted above, where the aggregate patient EMR data 126 may record the patient as having been prescribed and/or taking Metformin and later seeking medical treatment for renal failure. As a result, the mechanisms of the illustrative embodiments may generate a notification informing a medical practitioner of the contraindication and the options for modifying treatment, e.g., discontinuing the Metformin usage by the patient.

In addition to analyzing and evaluating medication instances in the aggregate patient EMR data 126 for valid/invalid duplicates and contra-indications, the medication interaction analysis engine 134 analyzes medication instances to determine if one medication instance negatively interacts with another medication instance. That is, the medication interaction analysis engine 134 operates to score a medication instance as to whether it should be removed from the patient's medication list data structure 124 based on the other medications that are in the patient's medication list data structure 124. The medication interactions may be evaluated based on pre-defined data structures indicating medication interactions, such as the medication resource information stored in the resource data structures 122, medication interaction information extracted from natural language content of natural language documentation, or the like. For example, mechanisms for analyzing positional statements, medical guideline documents, and the like, to extract insight data structures specifying treatments for medical conditions, which may include medication information, is described in commonly owned and co-pending U.S. patent application Ser. Nos. 15/278,066 and 15/278,089 (Attorney Docket Nos. SVL920160118US1 and SVL920160131US1), which may be used to generate such resource data structures 122 having medication interaction information. As described in these co-pending applications, a medical condition base cartridge is generated based on such analysis of guidelines and positional statements. A similar process may be used to generate medication based data structures that indicate details regarding medications for treating various medical conditions using natural language processing.

Thus, for example, the resource data structures 122 may include medication interaction information, such as may be obtained from pharmaceutical companies, government regulatory agencies, medical/pharmaceutical organizations, published documentation, and the like. For example, the resource data structures 122 may comprise a drug label database that has information for all drugs approved by the Federal Drug Administration (FDA) of the United States of America, along with the interactions, contraindications, and warnings that those drug labels contain. This drug label database is sometimes referred to as the Elsevier Gold Standard database. Of course, other databases of medication information may be used without departing from the spirit and scope of the present invention and may include other medication or drug information that may or may not have been approved by the FDA or other governmental regulation agency. This drug label database may be queried to retrieve information about particular medications of drugs and thereby highlight the interactions, contraindications, and determine similarities with other drugs or medications.

Hence, for a particular medication, a listing of other medications, classes of medications, or the like, with which the medication has negative interactions may be associated with that medication. This listing may be compared to other medication instances which are determined to be active medication instances in the aggregate patient EMR data 126 to determine if there are any interactions by other active medications in the aggregate patient EMR data 126. If a medication is determined to have a negative interaction by another medication in the patient's medication listing, then a corresponding notification may be sent to the medical professional that prescribed the medication to indicate the interaction and provide an interface through which the inclusion of the medication on the patient's medication list data structure 124 may be confirmed or rejected by a medical professional.

Moreover, the medication reconciliation engine 130 may further analyze cohorts of patients to reconcile medications in the medication listing data structure 124 for a patient based on the patient's medical condition. That is, in aggregating patient information for a plurality of patients, the patient information aggregation system 120 may identify cohorts of patients, i.e. groupings of patients that have similar attributes. In particular, with regard to the illustrative embodiments, the cohorts may be generated with regard to medical condition such that all patients that are part of a cohort have the same or similar medical condition. Cohorts may be nested such that one or more sub-cohorts of a cohort may be generated based on common attributes of the patients. As one example, a cohort for the medical condition “Diabetes” may be generated by the patient information aggregation system 120 and maintained in the resources data structure 122 as a set of pointers to patient EMR data for the patients that are part of the cohort. A sub-cohort of the “Diabetes” cohort may be “Type 2 Diabetes”. A sub-sub-cohort may be “Females 40 years or older.” Thus, patients in the sub-sub-cohort are female patients 40 years or older that have been diagnosed with Type 2 Diabetes.

Given a patient cohort defining a set of patients with similar medical conditions, the patient information for the patients in the cohort, e.g., the aggregate patient EMRs for the various patients, may be analyzed to determine whether a given patient is taking a medication even though the patient EMR data may not indicate such, whether the patient should be on the particular medication that other patients in the patient cohort are taking, whether there are contra-indications for prescribing the medication as indicated by other patient information, whether the patient is taking a medication for which the patient does not have a matching medical condition that the medication treats, or the like. For example, the resource data structures 122, and in particular a drug label database of the resources data structures 122, contain indication data which describes conditions each medication is used to treat. If there are no matching conditions in the patient's EMR, this contradiction may be used to flag that a medication may not be needed if it currently is present in the patient's medication listing data structure 124. This can happen as drug recommendations change over time, e.g., at one point in time it might be recommended that a certain cohort should be prescribed Statin drugs, but then a later medical study is conducted and it is discovered that it is only beneficial to a sub-set of the original cohort. The FDA will often release updates to the drug label information like this as additional studies about existing drugs/medications are completed. Moreover, as another example, if the majority of patients in a cohort are taking a prescribed or self-reported medication or supplement, and those patients do not have a medical condition that the present patient does not also have, then this may be an indication to check with the patient to see if they are also taking that same medication even though it is not presently listed in their medication listing data structure 124 by tentatively adding the medication to their medication listing or otherwise sending a notification to check with the patient. Thus, the medications of a cohort may be used to determine whether a particular patient's medication listing data structure 124 should be modified, how it should be modified, and/or whether to send a notification to the medical professional to query the patient further about the medications that they are taking.

The analysis of cohort based information provides a cohort score indicative of whether a medication should be removed from a patient's medication listing data structure 124 or alternatively included in the medication listing data structure 124. In some illustrative embodiments, the cohort score may be compared to one or more threshold score values indicative of whether a medication should be removed and whether the medication should be included in a patient's medication listing. If the cohort score for a medication meets or falls below a first threshold, then the medication may need to be removed from the patient's medication listing data structure 124, assuming that the medication is in the listing. If the cohort score for a medication meets or exceeds a second threshold, then the medication may need to be added to the patient's medication listing data structure 124, assuming it is not already present in the listing.

For example, the patient EMR data for other patients in the patient cohort may be evaluated to retrieve a medication listing data structure for the other patients and generate statistics regarding each medication listed in the medication listing data structures. These medication listing data structures may be already associated with the patient EMR data for the other patients by virtue of the operation of the illustrative embodiments on the patient information for these other patients and thus, may be retrieved and analyzed to generate statistics for various medications, e.g., a count of the number of patients taking a particular medication or medication of a particular class, or the like. Based on the counts of the medications in the medication listing data structures of other patients in the patient cohort, or other statistical measure, a determination may be made as to whether a medication appears in other patient medication listing data structures and should be listed in the present patient's medication listing data structure 124. For example, if a count of a medication being present in medication lists of other patients in the patient cohort meets or exceeds a predetermined threshold value, then it may be determined that this medication should be considered for inclusion in the medication listing data structure of the present patient. In such a case, a corresponding notification may be sent to a medical professional associated with the patient to obtain feedback as to whether to add the medication to the patient's listing and automatically generate a prescription for the medication.

This evaluation may utilize similar analysis as noted above with regard to duplicate medication analysis, contra-indications, and medication interactions, to determine if there are any reasons why the present patient should not have this medication included prior to sending the notification, i.e., if there is other information in the present patient's aggregate patient EMR data 126 indicating a duplicate medication of a same class is already present in the patient medication list data structure 124, is contra-indicated by the medical condition of the patient, or interferes with another medication on the patient's medication list 124, then a determination may be made not to send the notification even though other patients in the patient cohort may be taking the medication.

Moreover, other analysis of other aggregate patient EMR data for other patients in the patient cohort may be performed to identify instances where medications in the present patient's medication listing data structure 124 were considered but not included in the medication listing for the other patients, i.e. there are contra-indications in these other patients' EMR data. These contra-indications may be compared against characteristics of the present patient as indicated in the present patient's EMR data 126 to determine if similar contra-indications exist in the present patient's EMR data 126. If so, then again a notification may be sent to the medical professional determine whether the medication should be maintained in the medication listing data structure 124 for the present patient.

While the above description illustrates an embodiment in which each individual engine 132-135 may generate a notification to a corresponding medical professional to determine how to reconcile the medication information in the aggregate patient EMR data 126 so as to generate a medication listing data structure 124 in which valid instances of medications are listed, the illustrative embodiments are not limited to such. Rather, in addition to the individual notifications, or alternative to individual notifications by each of the engines 132-135, an aggregate scoring embodiment may be utilized in which scores are generated by each of the engines 132-135 and aggregated through a weighted evaluation to generate an aggregate score that may be used to determine whether to include or remove a medication from the patient's medication listing data structure 124.

That is, the medication scoring engine 136 may provide logic for generating various scores based on the evaluations made by the engines 132-135. The scores may be individually evaluated or evaluated in the aggregate to determine whether a medication should be removed from a particular patient's medication listing data structure 124. For example, if any of the different scores are sufficiently high to warrant removal (or addition) of the medication, then the medication may be removed from (or added to) the medication listing data structure 124 for the patient, and/or a notification may be sent to the patient and/or medical professional to provide feedback as to whether to keep, remove, or add a medication with regard to the medication listing data structure 124. Alternatively, a weighted aggregation of the scores may be used and compared to a threshold to determine whether the medication should be removed and/or corresponding notifications and feedback received. In the case of an aggregation, the notification may indicate the various reasons as to why the medication should be considered for removal and/or addition, to the medication listing data structure 124.

The patient's medical professional, e.g., doctor, nurse practitioner, etc., may always be provided with the opportunity to make the final determination as to whether to remove or add the medication or not, and thereby invalidate the currently active prescription for the medication, modify the prescription for the medication, or generate a new prescription for the medication. User interface elements may be provided for allowing the medical professional to respond to the notification to either confirm or deny removal/addition of the medication from the medication listing data structure 124, or alter the information associated with a medication in the medication listing data structure 124. Alternatively, or in addition, if the aggregate score is sufficiently above the threshold, then removal may be automatically performed in some illustrative embodiments, with appropriate after-the-fact notification to the patient and/or medical professional.

The mediation list update engine 137 provides the logic for managing the medication listing data structure 124 for a patient and updating the patient's aggregate patient EMR data 126 with the generated/modified medication list data structure 124. The combined aggregate patient EMR data 126 and medication list data structure 124 may be stored in the patient registry 140 which may be provided to the cognitive system 100 for use in performing cognitive operations. For example, the cognitive operations may comprise any suitable cognitive medical operation including, but not limited to, determining a range of treatment options that are preferred, acceptable, or not recommended based on the values of clinical attributes for the patient, generating medical observations, generating diagnoses from diagnostic tests, evaluating a medical condition of the patient based on medical lab tests, monitoring the medical condition of a patient, generating a medical treatment recommendation (it should be appreciated that a medical treatment recommendation may not be limited to recommending a treatment to be administered and may in fact represent a recommendation to stop or modify a treatment, or the like), or the like. Many different types of cognitive medical operations may be performed in accordance with one or more of the illustrative embodiments. The cognitive system 100 may utilize the request processing pipeline 108 to facilitate the performance of the cognitive operation based on the aggregate patient EMR data for the patient, including the medication listing data structure 124, in the patient registry 140.

It should be appreciated that, based on the updated medication listing data structure 124 for the patient, prescriptions for medications may be automatically invalidated and/or generated with medical professional review and approval. That is, if a medication is removed from the medication listing data structure 124, corresponding prescription information in the patient's aggregate EMR data 126 may be invalidated and corresponding notifications may be sent to the medical professionals, pharmacies, or the like, that may be involved in providing the medication to the patient. Similarly, if a medication is added, or conditions for administering the medication are changed, in the medication listing data structure 124, then corresponding notifications may be sent to the medical professionals, pharmacies, or the like, that are involved in the providing of the medication to the patient. Thus, in response to the medical professional authorizing the addition of a medication to the medication listing data structure 124, a prescription may be automatically generated and sent to the corresponding pharmacy or provider of the medication.

Thus, the illustrative embodiments provide automated computer based reconciliation of medication information in aggregate patient EMR data obtained from a variety of different sources of such patient information. The mechanisms of the illustrative embodiments resolve any duplicate medication instances in the aggregate patient EMR data, contra-indications by medical conditions of the patient, and interactions between medications. Moreover, cognitive evaluation of patient cohorts may be utilized to assist in reconciling medications in the patient's medication listing. Scoring logic is provided for scoring the various aspects of the medication instances in the aggregate patient EMR data so as to make a weighted evaluation of the various aspects to determine whether to recommend or at least notify a medical professional and/or the patient of a change to be made to the patient's medication listing data structure, e.g., to remove, modify, or add a medication entry in the medication listing data structure. Furthermore, prescriptions for medications may be automatically invalidated and/or generated based on the results of the analysis, with medical professional approval.

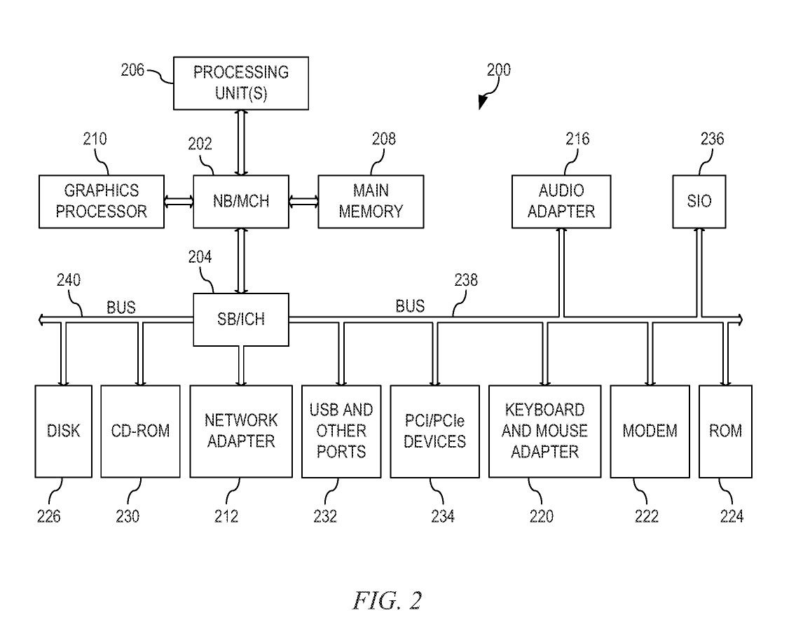

As noted above, the mechanisms of the illustrative embodiments are rooted in the computer technology arts and are implemented using logic present in such computing or data processing systems. These computing or data processing systems are specifically configured, either through hardware, software, or a combination of hardware and software, to implement the various operations described above. As such, FIG. 2 is provided as an example of one type of data processing system in which aspects of the present invention may be implemented through specific configuration of the data processing system to implement the mechanisms of one or more of the illustrative embodiments described herein. Many other types of data processing systems may be likewise configured to specifically implement the mechanisms of the illustrative embodiments.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including North Bridge and Memory Controller Hub (NB/MCH) 202 and South Bridge and Input/Output (I/O) Controller Hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p computer system, running the Advanced Interactive Executive (AIX®) operating system or the LINTJX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 is an example diagram illustrating an interaction of elements of a healthcare cognitive system in accordance with one illustrative embodiment. In particular, FIG. 3 illustrates an example in which the healthcare cognitive system 300 implements a treatment recommendation system which is used by a medical professional, such as user 306, to assist with decision making regarding the treatment of a patient 302. As part of this treatment recommendation cognitive operation, the healthcare cognitive system 300 utilizes one or more corpora 320 of information, which may include aggregate patient EMR data 322 which may be provided by a patient information aggregation system 300, such as a health information exchange (HIE) or the like. In some illustrative embodiments, in addition to providing the treatment recommendation cognitive operations, the healthcare cognitive system 300 itself may provide the patient information aggregation system 300.

Elements 330-347 are similar to elements of similar name and representation in FIG. 1, i.e. elements 120-137, and perform similar operations as discussed above, which will not be repeated here. To the contrary, FIG. 3 illustrates the way in which these mechanisms may be utilized to provide reconciled medication information for use in assisting with decision making support for treatment of a patient. While the example diagram of FIG. 3 depicts an implementation of a healthcare cognitive system 300 that is configured to provide medical treatment recommendations for patients, it should be appreciated that this is only an example implementation and other healthcare operations may be implemented in other embodiments of the healthcare cognitive system 300 without departing from the spirit and scope of the present invention.

Moreover, it should be appreciated that while FIG. 3 depicts the patient 302 and user 306 as human figures, the interactions with and between these entities may be performed using computing devices, medical equipment, and/or the like, such that entities 302 and 306 may in fact be computing devices, e.g., client computing devices. For example, the interactions 304, 314, 316, and 330 between the patient 302 and the user 306 may be performed orally, e.g., a doctor interviewing a patient, and may involve the use of one or more medical instruments, monitoring devices, or the like, to collect information that may be input to the healthcare cognitive system 300 as patient attributes 318. Interactions between the user 306 and the healthcare cognitive system 300 will be electronic via a user computing device (not shown), such as a client computing device 110 or 112 in FIG. 1, communicating with the healthcare cognitive system 300 via one or more data communication links and potentially one or more data networks.

As shown in FIG. 3, in accordance with one illustrative embodiment, a patient 302 presents symptoms 304 of a medical malady or condition to a user 306, such as a healthcare practitioner, technician, or the like. The user 306 may interact with the patient 302 via a question 314 and response 316 exchange where the user gathers more information about the patient 302, the symptoms 304, and the medical malady or condition of the patient 302. It should be appreciated that the questions/responses may in fact also represent the user 306 gathering information from the patient 302 using various medical equipment, e.g., blood pressure monitors, thermometers, wearable health and activity monitoring devices associated with the patient such as a FitBit™, a wearable heart monitor, or any other medical equipment that may monitor one or more medical characteristics of the patient 302. In some cases such medical equipment may be medical equipment typically used in hospitals or medical centers to monitor vital signs and medical conditions of patients that are present in hospital beds for observation or medical treatment.

In response, the user 302 submits a request 308 to the healthcare cognitive system 300, such as via a user interface on a client computing device that is configured to allow users to submit requests to the healthcare cognitive system 300 in a format that the healthcare cognitive system 300 can parse and process. The request 308 may include, or be accompanied with, information identifying patient attributes 318. These patient attributes 318 may include, for example, an identifier of the patient 302 from which patient EMRs 322 for the patient may be retrieved, demographic information about the patient, the symptoms 304, and other pertinent information obtained from the responses 316 to the questions 314 or information obtained from medical equipment used to monitor or gather data about the condition of the patient 302. Any information about the patient 302 that may be relevant to a cognitive evaluation of the patient by the healthcare cognitive system 300 may be included in the request 308 and/or patient attributes 318.

The healthcare cognitive system 300 provides a cognitive system that is specifically configured to perform an implementation specific healthcare oriented cognitive operation. In the depicted example, this healthcare oriented cognitive operation is directed to providing a treatment recommendation 328 to the user 306 to assist the user 306 in treating the patient 302 based on their reported symptoms 304 and other information gathered about the patient 302 via the question 314 and response 316 process and/or medical equipment monitoring/data gathering. The healthcare cognitive system 300 operates on the request 308 and patient attributes 318 utilizing information gathered from the medical corpus and other source data 326, treatment guidance data 324, and the patient EMRs 322 associated with the patient 302 to generate one or more treatment recommendation 328. The treatment recommendations 328 may be presented in a ranked ordering with associated supporting evidence, obtained from the patient attributes 318 and data sources 322-326, indicating the reasoning as to why the treatment recommendation 328 is being provided and why it is ranked in the manner that it is ranked.

For example, based on the request 308 and the patient attributes 318, the healthcare cognitive system 300 may operate on the request, such as by using a QA pipeline type processing as described herein, to parse the request 308 and patient attributes 318 to determine what is being requested and the criteria upon which the request is to be generated as identified by the patient attributes 318, and may perform various operations for generating queries that are sent to the data sources 322-326 to retrieve data, generate candidate treatment recommendations (or answers to the input question), and score these candidate treatment recommendations based on supporting evidence found in the data sources 322-326.

In the depicted example, the patient EMRs 322 is a patient information repository that collects patient data from a variety of sources, e.g., hospitals, laboratories, physicians' offices, health insurance companies, pharmacies, etc. The patient EMRs 322 store various information about individual patients, such as patient 302, in a manner (structured, unstructured, or a mix of structured and unstructured formats) that the information may be retrieved and processed by the healthcare cognitive system 300. This patient information may comprise various demographic information about patients, personal contact information about patients, employment information, health insurance information, laboratory reports, physician reports from office visits, hospital charts, historical information regarding previous diagnoses, symptoms, treatments, prescription information, etc. In particular, with regard to the illustrative embodiments, the patient EMRs 322 comprise aggregate patient EMR data aggregated from a variety of different sources by the patient information aggregation system 330, and including reconciled medication information, such as a medication listing data structure, for the patient as generated by the medication reconciliation engine 340 in the manner described above with regard to one or more illustrative embodiments. Based on an identifier of the patient 302, the patient's corresponding EMRs 322 from this patient repository may be retrieved by the healthcare cognitive system 300 and searched/processed to generate treatment recommendations 328.

The treatment guidance data 324 provides a knowledge base of medical knowledge that is used to identify potential treatments for a patient based on the patient's attributes 318 and historical information presented in the patient's EMRs 322. This treatment guidance data 324 may be obtained from official treatment guidelines and policies issued by medical authorities, e.g., the American Medical Association, may be obtained from widely accepted physician medical and reference texts, e.g., the Physician's Desk Reference, insurance company guidelines, or the like. The treatment guidance data 324 may be provided in any suitable form that may be ingested by the healthcare cognitive system 300 including both structured and unstructured formats.

In some cases, such treatment guidance data 324 may be provided in the form of rules that indicate the criteria required to be present, and/or required not to be present, for the corresponding treatment to be applicable to a particular patient for treating a particular symptom or medical malady/condition. For example, the treatment guidance data 324 may comprise a treatment recommendation rule that indicates that for a treatment of Decitabine, strict criteria for the use of such a treatment is that the patient 302 is less than or equal to 60 years of age, has acute myeloid leukemia (AML), and no evidence of cardiac disease. Thus, for a patient 302 that is 59 years of age, has AML, and does not have any evidence in their patient attributes 318 or patient EMRs indicating evidence of cardiac disease, the following conditions of the treatment rule exist:

Age<=60 years=59 (MET);

Patient has AML=AML (MET); and

Cardiac Disease=false (MET)

Since all of the criteria of the treatment rule are met by the specific information about this patient 302, then the treatment of Decitabine is a candidate treatment for consideration for this patient 302. However, if the patient had been 69 years old, the first criterion would not have been met and the Decitabine treatment would not be a candidate treatment for consideration for this patient 302. Various potential treatment recommendations may be evaluated by the healthcare cognitive system 300 based on ingested treatment guidance data 324 to identify subsets of candidate treatments for further consideration by the healthcare cognitive system 300 by scoring such candidate treatments based on evidential data obtained from the patient EMRs 322 and medical corpus and other source data 326.

For example, data mining processes may be employed to mine the data in sources 322 and 326 to identify evidential data supporting and/or refuting the applicability of the candidate treatments to the particular patient 302 as characterized by the patient's patient attributes 318 and EMRs 322. For example, for each of the criteria of the treatment rule, the results of the data mining provides a set of evidence that supports giving the treatment in the cases where the criterion is “MET” and in cases where the criterion is “NOT MET.” The healthcare cognitive system 300 processes the evidence in accordance with various cognitive logic algorithms to generate a confidence score for each candidate treatment recommendation indicating a confidence that the corresponding candidate treatment recommendation is valid for the patient 302. The candidate treatment recommendations may then be ranked according to their confidence scores and presented to the user 306 as a ranked listing of treatment recommendations 328. In some cases, only a highest ranked, or final answer, is returned as the treatment recommendation 328. The treatment recommendation 328 may be presented to the user 306 in a manner that the underlying evidence evaluated by the healthcare cognitive system 300 may be accessible, such as via a drilldown interface, so that the user 306 may identify the reasons why the treatment recommendation 328 is being provided by the healthcare cognitive system 300.

While FIG. 3 is depicted with an interaction between the patient 302 and a user 306, which may be a healthcare practitioner such as a physician, nurse, physician's assistant, lab technician, or any other healthcare worker, for example, the illustrative embodiments do not require such. Rather, the patient 302 may interact directly with the healthcare cognitive system 300 without having to go through an interaction with the user 306 and the user 306 may interact with the healthcare cognitive system 300 without having to interact with the patient 302. For example, in the first case, the patient 302 may be requesting 308 treatment recommendations 328 from the healthcare cognitive system 300 directly based on the symptoms 304 provided by the patient 302 to the healthcare cognitive system 300. Moreover, the healthcare cognitive system 300 may actually have logic for automatically posing questions 314 to the patient 302 and receiving responses 316 from the patient 302 to assist with data collection for generating treatment recommendations 328.

In the latter case, the user 306 may operate based on only information previously gathered and present in the patient EMR 322 by sending a request 308 along with patient attributes 318 and obtaining treatment recommendations in response from the healthcare cognitive system 300. Thus, the depiction in FIG. 3 is only an example and should not be interpreted as requiring the particular interactions depicted when many modifications may be made without departing from the spirit and scope of the present invention. It should be appreciated, however, that at no time should the treatment itself be administered to the patient 302 without prior approval of the healthcare professional treating the patient, i.e. final determinations as to treatments given to a patient will always fall on the healthcare professional with the mechanisms of the illustrative embodiments serving only as an advisory tool for the healthcare professional (user 306) and/or patient 302.

As mentioned above, the healthcare cognitive system 300 may include a request processing pipeline, such as request processing pipeline 108 in FIG. 1, which may be implemented, in some illustrative embodiments, as a Question Answering (QA) pipeline. The QA pipeline may receive an input question, such as “what is the appropriate treatment for patient P?”, or a request, such as “diagnose and provide a treatment recommendation for patient P.”

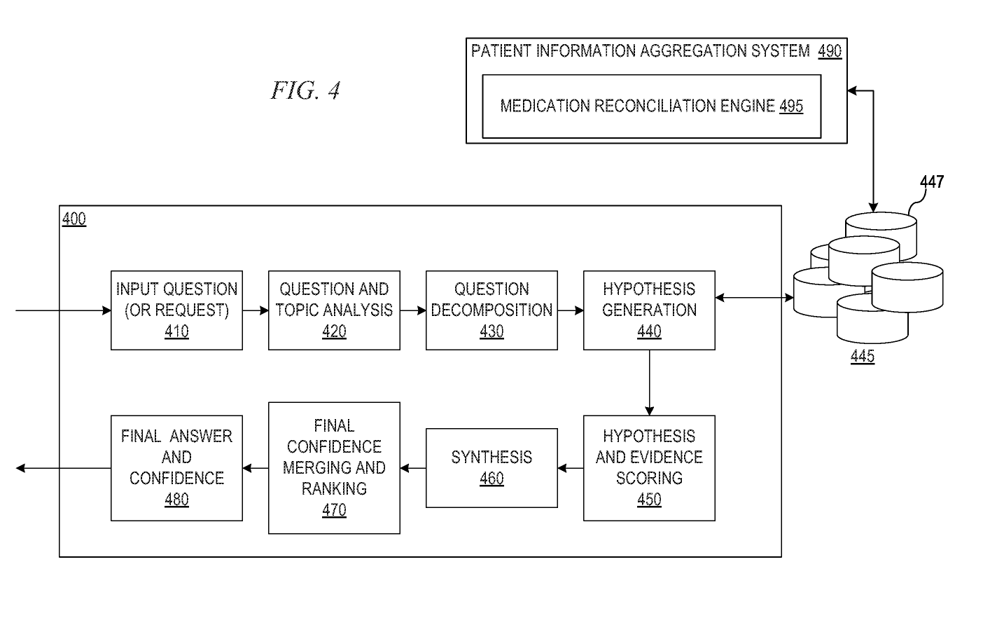

FIG. 4 illustrates a QA pipeline of a healthcare cognitive system, such as healthcare cognitive system 300 in FIG. 3, or an implementation of cognitive system 100 in FIG. 1, for processing an input question in accordance with one illustrative embodiment. It should be appreciated that the stages of the QA pipeline shown in FIG. 4 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA pipeline of FIG. 4 is augmented, for example, in one or more of the stages to implement the improved mechanism of the illustrative embodiments described hereafter, additional stages may be provided to implement the improved mechanism, or separate logic from the pipeline 400 may be provided for interfacing with the pipeline 400 and implementing the improved functionality and operations of the illustrative embodiments.

As shown in FIG. 4, the QA pipeline 400 comprises a plurality of stages 410-480 through which the cognitive system operates to analyze an input question and generate a final response. In an initial question input stage 410, the QA pipeline 400 receives an input question that is presented in a natural language format. That is, a user inputs, via a user interface, an input question for which the user wishes to obtain an answer, e.g., “What medical treatments for diabetes are applicable to a 60 year old patient with cardiac disease?” In response to receiving the input question, the next stage of the QA pipeline 400, i.e. the question and topic analysis stage 420, parses the input question using natural language processing (NLP) techniques to extract major features from the input question, and classify the major features according to types, e.g., names, dates, or any of a plethora of other defined topics. For example, in a question of the type “Who were Washington's closest advisors?”, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic. Similarly, in the previous question “medical treatments” may be associated with pharmaceuticals, medical procedures, holistic treatments, or the like, “diabetes” identifies a particular medical condition, “60 years old” indicates an age of the patient, and “cardiac disease” indicates an existing medical condition of the patient.

In addition, the extracted major features include key words and phrases, classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “ drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 4, the identified major features are then used during the question decomposition stage 430 to decompose the question into one or more queries that are applied to the corpora of data/information 445 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 445. That is, these various sources themselves, different collections of sources, and the like, represent a different corpus 447 within the corpora 445. There may be different corpora 447 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 447 within the corpora 445.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 440 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 440, to generate hypotheses for answering the input question. These hypotheses are also referred to herein as “candidate answers” for the input question. For any input question, at this stage 440, there may be hundreds of hypotheses or candidate answers generated that may need to be evaluated.

The QA pipeline 400, in stage 450, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 460, the large number of scores generated by the various reasoning algorithms are synthesized into confidence scores or confidence measures for the various hypotheses. This process involves applying weights to the various scores, where the weights have been determined through training of the statistical model employed by the QA pipeline 400 and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 400 that identifies a manner by which these scores may be combined to generate a confidence score or measure for the individual hypotheses or candidate answers. This confidence score or measure summarizes the level of confidence that the QA pipeline 400 has about the evidence that the candidate answer is inferred by the input question, i.e. that the candidate answer is the correct answer for the input question.

The resulting confidence scores or measures are processed by a final confidence merging and ranking stage 470 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 480, a final answer and confidence score, or final set of candidate answers and confidence scores, are generated and output to the submitter of the original input question via a graphical user interface or other mechanism for outputting information.

As shown in FIG. 4, in accordance with one illustrative embodiment, the corpus or corpora 445, 447 upon which the pipeline 400 operates may include aggregate patient EMR data that is aggregated from a variety of different sources by the patient information aggregation system 490, such as in the manner previously described above. For example, the patient information aggregation system 490 may implement a health information exchange (HIE) or other mechanism for aggregating patient information. The patient information aggregation system 490 comprises a medication reconciliation engine 495, which may be the medication reconciliation engine 130 in FIG. 1 configured in accordance with one or more of the illustrative embodiments described above with regard to FIG. 1. The resulting aggregate patient EMR data and the reconciled medication information for the patients, such as may be provided in medication listing data structures associated with each patient's aggregate patient EMR data, for example, may be used by the pipeline 400 to generate candidate answers or responses to requests and evaluate them with regard to evidential scoring and the like. For example, as noted above, in some illustrative embodiments, the pipeline 400 may be used to cognitively evaluate the aggregate patient EMR data for a patient present in the corpus or corpora 445, 447 and the reconciled medication information with regard to potential treatments for a medical condition of the patient. It can be appreciated that for such an evaluation, it is important to have a complete picture of the patient's medical condition, as may be determined from an aggregation of patient information from a variety of sources, as well as an accurately reconciled understanding of the medications that the patient is taking.

Thus, the illustrative embodiments provide mechanisms for generating aggregate patient information, reconciling medication information in such aggregate patient information, and performing cognitive healthcare based operations based on the aggregate patient information and reconciled medication information. As an example scenario, consider a situation in which a patient has medication related information from various sources including an EMR A, a Pharmacy B and MedApp C, an EMR D, and a Pharmacy E all with various information related to medications. In the EMR A, a data entry of type medication is specified with Ibuprofen ordered on May 5, 2010, and Pharmacy B has dispense information for Ibuprofen on May 7, 2010 in Raleigh, N.C. MedApp C has Advil being taken for pain on May 7, 2010 and EMR D has Motrin as an order for medication specified from January 2009, and Pharmacy E has Ibuprofen dispense information on May 14 in Orlando, Fla. Based on the data types, medication dispense, dates, orders, medications, and generic names all related to the medication, they are weighted based on type and whether the values semantically or semantically match to attribute to a score that when above a threshold it will be determined to be a duplicate.

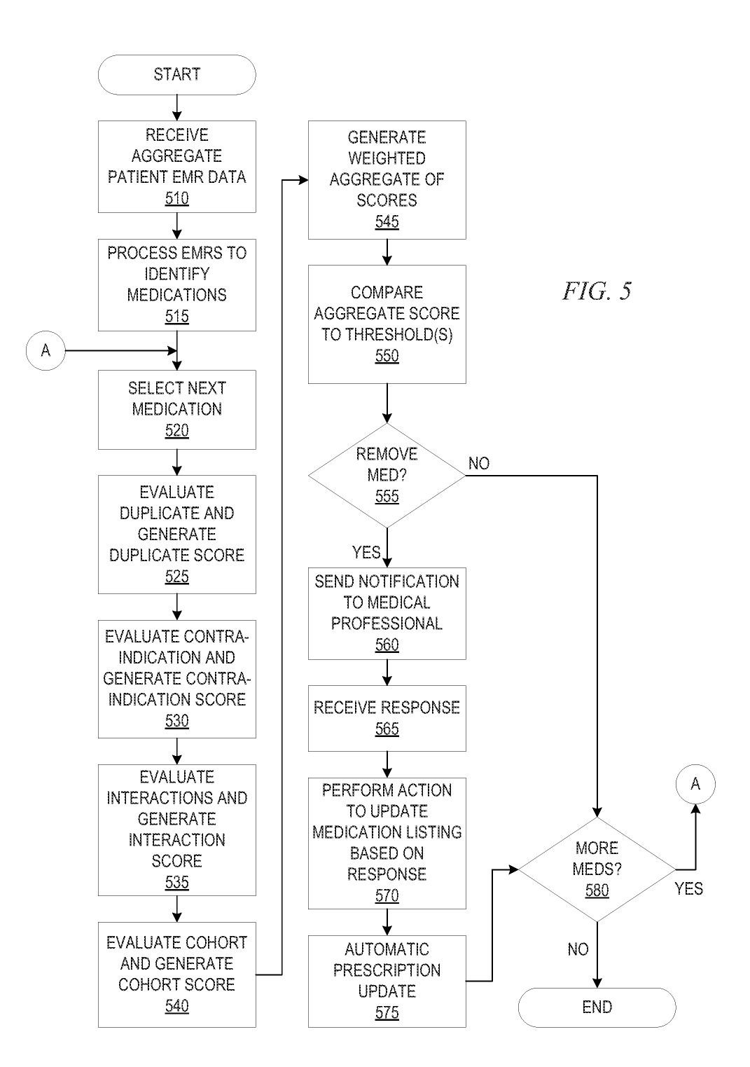

FIG. 5 is a flowchart outlining an example operation for performing medication reconciliation in accordance with one illustrative embodiment. The illustrative embodiment shown in FIG. 5 assumes an embodiment in which an aggregate scoring methodology is utilized for determining whether to modify a medication listing associated with a patient. However, as noted above, other illustrative embodiments may implement each individual engine determining whether to send notifications and modify a medication listing based on its own individual evaluation of the medication information in the aggregate patient EMR data.

Also, FIG. 5 is shown with regard to the operation being performed for a single patient, however it should be appreciated that the same operation may be performed for a plurality of patients and may be repeatedly performed for each patient on a dynamic basis as updates to patient information from various sources are received. Furthermore, FIG. 5 is shown with regard to determining whether to remove a medication from a medication listing being generated from an aggregation of patient EMR data. However, it should be appreciated that similar operations may be performed with regard to determining whether to modify an entry for a medication in the medication listing or add a medication to a medication listing for the patient, as discussed previously above.

As shown in FIG. 5, the operation starts by receiving aggregate patient EMR data from a plurality of different sources of patient information, i.e. patient EMRs (step 510). For example, patient EMRs may be received from hospitals, doctor offices, medical laboratories, emergency care facilities, pharmacies, medical equipment providers, or any other source of patient information. The various patient EMRs may be correlated with one another via one or more patient identifiers that indicate that the various patient EMRs are associated with a same patient. The various patient EMRs may have medical condition information, patient characteristic information, treatment information, medication information, and the like, which may need to be aggregated and reconciled. In particular, the patient EMRs may have medication information which is reconciled using the mechanisms of the illustrative embodiments.

The aggregate patient EMR data is processed to identify instances of medications being referenced in the patient EMRs (step 515). For a next medication identified in the patient EMR (step 520), the medication is evaluated to determine if the medication is a duplicate of another medication listed in the patient EMR and generate a duplicate score (step 525). In some illustrative embodiments, the generation of the duplicate score may include evaluation of the duplicate to determine the likelihood that the duplicate is a valid or invalid duplicate, such that the measure of validity of the duplicate may be used as a basis for determining the duplicate score.

For the medication, an evaluation of the medical condition of the patient relative to the specific information for the medication is performed to determine if the medication is contra-indicated by the medical condition of the patient in the aggregate patient EMR data for the patient and a contra-indication score is generated (step 530). The medication is then evaluated to determine if there are any interactions of the medication with other medications in the aggregate patient EMR data for the patient and an interaction score is generated (step 535). A cohort analysis of the medication relative to patient EMR data for other patients in a patient cohort corresponding to the medical condition of the current patient is performed and a cohort score is generated (step 540).

The duplicate score, the contra-indication score, the interaction score, and the cohort score are weighted and aggregated to generate an aggregate score for determining whether the medication should be removed from the medication listing data structure for the patient (step 545). The weights applied to the various scores may be specified by a subject matter expert, may be learned through a machine learning process, or the like. The weights indicate the relative importance of the corresponding score to the overall determination as to whether to remove a medication from the medication listing data structure for a patient. It should be appreciated that similar weightings and evaluation may be performed for modifications or additions to the medication listing data structure as well.

The aggregate weighted score is compared to one or more threshold values (step 550) and a determination is made, based on the comparison results, as to whether or not the medication should be considered for removal from the medication listing for the patient (step 555). In response to a determination that the medication should be considered for removal from the medication listing, a notification of the recommendation for removal is sent to a medical professional, such as a medical professional that is the source of the prescription for the medication being considered, a medical professional primarily responsible for treatment of the patient, or the like (step 560). The notification may include user interface elements for allowing the medical professional to provide feedback indicating agreement with or disagreement with the recommended action of removing the medication from the medication listing data structure for the patient. A response to the notification may be received from the medical professional, in response to the medical professional utilizing the user interface of the notification (step 565). A corresponding action is then performed to update the medication listing data structure to either remove or maintain the medication in the medication listing based on the response (step 570). Optionally, prescription information for the medication may be automatically updated, invalidated, or the like, based on the update to the medication listing and the prescription information may be automatically transmitted to a provider of the medication to the patient (step 575). The patient may be notified of any such changes as well. It should be appreciated that the above notifications are preferably sent via electronic mechanisms to computing devices and/or communication devices associated with the identified parties mentioned above.

Thereafter, or in response to a determination that the medication should not be removed, the operation determines if there are more medications specified in the aggregate patient EMR data (step 580). If so, the operation returns to step 525. Otherwise, the operation terminates.

As mentioned above, one of the operations performed once a potential duplicate medication has been identified in the patient EMR, is to determine whether the potential duplicate medication is a valid or invalid duplicate. This determination may further influence the duplicate score generated, such as in step 525 of FIG. 5, which may be used along with other scores, or by itself, to determine whether to remove a medication from the patient's medication listing data structure, send notifications to medical professionals treating the patient, send notifications to the patient, and/or automatically invalidate prescriptions at dispensing locations, e.g., pharmacies or the like. For example, in some illustrative embodiments, if it is determined that the medication is a duplicate medication in step 525 of FIG. 5, and it is further determined that the medication is an invalid duplicate, the value associated with the duplicate score as well as the weighting applied to the duplicate score may heavily outweigh any of the other factors, e.g., contraindication score, interaction score, cohort score, etc. In fact, in some cases, the duplicate score may be compared to a threshold value at step 525 and, if a criteria of the threshold value is met by the duplicate score, then steps 530-555 of FIG. 5 may be bypassed and the notification to the medical professional in step 560 and the subsequent steps may be followed for the medication.

Thus, if potential duplicative medications have been prescribed to the patient from different sources, i.e. instances of the same medication are found in the aggregate patient EMR but from different sources, or duplicative medications of a same class are found in the aggregate patient EMR but from different sources, then further analysis is performed to determine whether the instances are in fact incorrect or invalid duplicates or if the multiple instances of medications are likely valid duplications.

As discussed previously with regard to FIG. 1, the duplicate medication analysis engine 132 provides logic for analyzing various features or characteristics of the medication entries, such as may be provided as data types and corresponding values, in the aggregate patient EMR to come to a cognitive conclusion as to the likelihood that one medication is a valid or invalid duplicate of another medication. This logic may evaluate various predefined rules that weigh different factors to generate validity scores as to whether a potential duplicate medication is a valid or invalid duplicate. The weights to be assigned to the various factors of the rules that are evaluated may be learned over time using a machine learning process, assigned by subject matter experts, or by a combination of automated machine learning and manual setting/adjustment of such weights by subject matter experts. Each of the rules generate one or more component values to the cognitive evaluation of a validity score for an identified potential duplicate medication instance, e.g., medication B is the same or similar medication as medication A, and this duplicate is either valid or invalid.

As part of this cognitive evaluation of the medication instances in the aggregate patient EMR, the duplicate analysis engine 132 analyzes various factors as elements of such rules including, but not limited to, timing information associated with the instances of the mediations in the patient's aggregate EMR data, source information associated with the instances indicative of the type of source that provided the prescription or dispensing of the medication or the type of services that the source provides, relative distances between the sources and known locations associated with the patient, dosage amounts associated with the various instances of potentially duplicate medications, and other factors that are indicative of whether or not one medication instance is a valid or invalid duplicate of another medication instance.

For example, the dates and/or times associated with the instances of medications being prescribed, dispensed, or the like, may be extracted from the aggregate patient EMR data along with other features including indications of the source that are correlated with information indicating characteristics of known sources of patient information, such as the geographic location of the source, the type of facility of the source (e.g., Emergency Room, Ambulatory, Clinic, Hospital, Pharmacy, etc.), type of medical practice provided by the source (e.g., a doctor that is a podiatrist, while another doctor's medical practice may be an internal medicine doctor, etc.), and the like. In addition, information about the patient, such as home and work addresses, and the like, that may be relevant for analysis of whether a medication is a valid or invalid duplicate may also be retrieved from the aggregate patient EMR data.

In order to verify the duplicate prescription, the location of the source may be compared to other locations of sources of medical services the patient has utilized, the location of the patient's home and work, and the like, to determine if the location of a source of a duplicate medication is relatively near these other locations. For example, if a potential duplicate medication is prescribed by a medical professional, or dispensed by a dispensing source, within a given threshold distance of a known location for the patient, e.g., their home, their work, a doctor's office they frequent, or the like, but not at a location previously noted in the patient EMR data as a source of medication instances, then it is more likely than not that the duplicate medication may be an invalid duplicate, where an “invalid” duplicate means that the patient should not be taking the medication since they are already taking another medication that provides the same or similar effects. This does not necessarily mean that the patient has nefariously attempted to obtain more medication than they should have, although in some situations that may be the case, but could instead represent a situation where a doctor prescribes the medication, or a pharmacy dispenses the medication, without full knowledge of the other medications that the patient has been prescribed or is currently taking.

As another example, if the location of a source of a medication instances in the aggregate patient EMR is further away than the threshold distance, or a certain amount further away from the threshold distance, this may indicate a valid duplicate as the patient is likely traveling or otherwise not in a location where they can have their original prescription for the medication fulfilled at a routine dispensing location or visit their normal doctor, e.g., the patient is on vacation and forgot to bring their medication, misplaced their medication, forgot to fulfill a prescription before traveling, or the like.

The date and time information associated with the instances of medications being present in the aggregate patient EMR data may also be analyzed and compared to evaluate whether a duplicate is a valid or invalid duplicate. For example, if a same or similar medication has been dispensed by two different sources within a specified time period of each other, this may be indicative of an invalid duplication of the medication or similar medication. If the dates/times are sufficiently spread apart relative to one another, this may be more indicative of a valid duplicate. However, this may be evaluated in connection with the time periods for which the medications are dispensed, e.g., if a medication is dispensed at one source with 30 pills and one pill taken each day, then if the same or similar medication is dispensed at another nearby source within 15 days of the first dispensing of the medication, this could be indicative of an invalid duplicate medication.

Similarly, in a case where there are two instances of the same medication being prescribed, such as due to a follow up visit with the patient's primary care physician (PCP), a location of the source of the instances will be similar, the institution of the source will be similar, and the duration of time between the instances of medication prescriptions will be larger and may coincide with a previous prescription expiration time (another feature that may be extracted from the medication information in the patient EMR data). This is indicative of the subsequent instance of the medication prescription being a renewal or additional prescription to supplement the previous prescription and is not in fact a duplicate medication prescription. Thus, while the medication instances may be duplicative, they are valid duplicates.

In addition to location information for the sources of the duplicate medication instances and the data/timing information for the duplicate medication instances, various information regarding the sources themselves may be evaluated to determine the potential likelihood of validity or invalidity of the duplicate medication instances. For example, the types of sources, e.g., hospital, pharmacy, doctor's office, etc., the types of services provided by the sources, whether the source is in or out of network for the patient's medical insurance, and a plethora of other factors regarding the nature of the sources themselves may be evaluated using the mechanisms of the illustrative embodiments. For example, if a first medication instance is from the patient's principle care physician, and a second medication instance is from a hospital, then it is possible that the duplicate medication instances may be valid.

In addition, any context information extracted along with the instances of the medications in the aggregate patient EMR data may be analyzed, such as by way of natural language processing, to identify any reasoning for the duplicate prescription instance in the aggregate patient EMR data. For example, a source of a duplicate medication instance may specifically state that the reason for the duplicate medication instance is to provide it as a replacement for a lost prescription bottle. Moreover, natural language text in the aggregate patient EMR may indicate that the subsequent medication instance may be because the first medication instance was for too low a dosage or is a similar medication that is intended to replace the previous medication because of an allergic reaction or other reasoning. Thus, natural language processing may be applied to the context information by the logic of the illustrative embodiments to thereby extract features from the natural language of the context information and correlate those features, e.g., key words and phrases, with knowledge of those specific features and their meaning in the context of duplicate medication instance validity/invalidity.

Furthermore, dosage information may be evaluated for the duplicate medication instances as yet another factor in the determination as to whether the duplicate medication instances are valid or invalid. For example, dosages may be compared so as to determine whether one dosage is significantly different from another dosage for the duplicate medication instances of the same or similar medications, and this may be included as an additional evaluation factor. For example, if a comparison of the locations of the sources of the duplicate medication instances indicates a large location difference, e.g., larger than a predetermined threshold distance from one another, and in the subsequent medication instance the dosage is significantly smaller than a normal dosage and duration for a typical prescription for the medication, this is indicative of the subsequent medication instance being categorized as an “away replacement,” i.e. a replacement for the medication obtained while the patient is traveling due to a misplaced medication or failure to bring the medication.

Similarly, in embodiments where medical insurance claims information is evaluated in the aggregate patient EMR data, if insurance claims information indicates that the subsequent medication instance is a mid-duration change in dosage and/or amount of the medication, and the medication prescription is filled via a shipping method, then this duplicate medication instance may be evaluated to be a “mail replacement.” Moreover, if the difference in locations of the sources is relatively small, and the dosage is relatively the same for the duplicate medication instances, then this is more evidence that the duplicate is likely an invalid duplicate.

As noted above, in some cases, a medication may in fact be a combination of medications which may be indicative of an invalid duplicate if two or more medications have components that are duplicative and which are prescribed and/or dispensed within a predefined period of time of each other. This may occur with regard to prescription/dispensing information as well as other purchase information or information provided by the patient as to medications that do not require prescriptions, such as over-the-counter medications. Thus, in addition to the other evaluations noted above, active ingredients in the medications of the duplicate medication instances may be evaluated to determine any overlap in the active ingredients that may be indicative of an invalid duplicate medication.

In addition, the analyzing of filled prescription information from a pharmacy or other dispensers/providers of medications, is used by the duplicate medication analysis engine to note the location the prescription was filled, the date filled, and any refills, and the amount of dosage and times to complete taking the medication. The information obtained from the aggregate patient EMR data including such filled prescription information from a pharmacy or provider of medication, may be correlated with additional information about the medication which may be present in the resource data structures to obtain a general understanding of the medication, the type or class of the medication, the general way in which the medication is taken, the effects of the medication, the interactions of the medication with other medications, and the like. The combination of resource information about the medication and the actual instances of the medication and their context information in the aggregate patient EMR data, a determination may be made as to when the patient should be taking the medication, when the prescription for the medication is to expire, and the like. Based on this information cross-referenced against prescription entries in the patient's aggregated EMR information, a medication is given a weighted score towards its usage having been completed, i.e. a weighted score as to whether the patient has already completed the prescribed treatment using the medication or not prior to, or at the same time, that another prescription for the medication, or a medication of the same class, was made.

This information, as well as other information in the aggregate patient EMR data, such as dates of medication instances relative to a current date, dates of last fulfillment of a prescription relative to the current date, and the like, may be used to determine whether a medication instance in the aggregate patient EMR data is an actively taken medication or is inactive. For example, medication instances in the aggregate patient EMR data that are more than a predetermined period of time older than the current time, and for which no subsequent prescription fulfillment data is present in the aggregate patient EMR data, may be determined to be inactive. Similarly, medication instances that are current relative to the current time, but which do not show as having been fulfilled by a pharmacy since prescribed, may be considered inactive. Other medication instances may be considered active.

As another example, known allergies in the aggregated patient EMR data may be identified and compared against an ingredient listing of an earlier prescribed medication of a duplicate to identify if any active or inactive ingredient in that medication is associated with one of the known allergies identified in the aggregate patient EMR. If the earlier prescribed medication matches a known allergy of the patient as indicated in the aggregate patient EMR data, then the later prescription is more likely a replacement of the earlier one due to an allergic reaction. As a result, the earlier prescribed medication may be considered inactive while the later prescribed medication may be considered active.

The active/inactive status of a medication instance may be dynamically modified based on additions to the aggregate patient EMR data when the patient fulfills a prescription at a pharmacy that reports such information to the patient information aggregation system. Whether or not a medication instance is active/inactive is another factor that may be weighted and scored in combination with other factors to determine whether a medication instance is a duplicate and whether that duplicate is valid/invalid.

As can be appreciated, many other factors may be evaluated to determine whether an instance of a medication in the aggregate patient EMR data is a duplicate of another medication, e.g., has a same class of medication, provides a similar treatment or effect, addresses a same or similar medical condition, is known to be a substitute for the other medication, or the like. The above factors are only intended to be examples of factors that may be considered when evaluating whether a duplicate medication instances is valid or invalid and is not intended to be exhaustive of such factors. Any factors pertinent to such an evaluation are intended to be within the spirit and scope of the present invention.

Thus, with the mechanisms of some illustrative embodiments, having determined that there is a duplicate medication instance present in the aggregate patient EMR data, a determination is made based on various factors as to whether the duplicate medication instance in the aggregate patient EMR data is a valid duplicate or invalid duplicate. This evaluation may be performed by retrieving duplicate medication validity evaluation rules that are then applied to features extracted from aggregate patient EMR data for the patient, and in particular with regard to the instances of the medications present in the aggregate patient EMR data that are determined to be duplicate medication instances. In some cases, the rules may be specific to the type or class of medication involved in in the duplicate medication instances. For example, there may be different factors evaluated for different classes or types of medications, different weightings applied to different factors, or the like. Thus, in some embodiments, based on the class(es) or type(s) of medication that is involved in the duplicate medication instances, a subset of rules from a duplicate validity evaluation rules repository, which may be maintained for example, by the duplicate medication analysis engine 132, or stored in resources data structures 122 of FIG. 1, corresponding to the class(es) or type(s) may be retrieved and applied to the extracted features.

In applying the rules to the extracted features, each of the rules may evaluate one or more feature and apply appropriate weighting values to these features to generate a component value to be combined with other component values of other rules so as to generate an aggregate validity score value. The weighting values applied to these features are indicate of a relative strength of the indication of that feature as to whether a valid or invalid duplicate is present. In addition to applying weighting values to the individual features within a rule, the resulting component values may likewise be weighted differently according to their relative strengths in determining the validity or invalidity of a duplicate medication instance when combining the component values to generate an aggregate validity score value.

The aggregate validity score value may be compared to one or more threshold values to determine whether or not the aggregate validity score indicates the duplicate medication instance to be a valid or invalid duplicate. For example, in some embodiments, if the aggregate validity score is equal to or above a first threshold value, then it is determined to be a valid duplicate. If the aggregate validity score is below the first threshold, but above a second threshold, then the duplicate may be considered to be “indeterminate,” i.e. it cannot be determined whether the duplicate is valid or invalid. If the aggregate validity score is equal to or below the second threshold, then the duplicate may be considered to be an invalid duplicate.

The duplicate medication analysis engine, such as duplicate medication analysis engine 132, which is applying this logic, the rules, and making these evaluations, generates a determination, for each instance of a medication in the aggregate patient EMR data for a patient, whether that instance of the medication is likely a valid or invalid duplicate of another medication in the aggregate patient EMR data. In response, the medication reconciliation engine 130 may send a notification to the patient and/or a current or primary medical professional treating the patient, or the medical professional that is the source of the duplicative medication instance, to inform them of the potential need to modify the medications prescribed to the patient. The notification may be sent to a computing device associated with the patient/medical professional via the network so as to inform the medical professional of the potentially invalid duplicate medication instance and giving them an interface through which they can confirm/reject the duplicate medication instance as being valid. The response from the medical professional may be received by the medication reconciliation engine and used by the medication list update engine to determine whether to include or remove the duplicate medication instance from the medication list associated with the patient and the aggregate patient EMR data for the patient.

This notification may be done as a bypass operation in the flow of FIG. 5 such that the operations in steps 530-555 are bypassed. Alternatively, the evaluation of the validity of the duplicate medication instances may be used to generate a duplicate score as part of step 525, where the duplicate score may be based on whether or not the duplicate is valid or invalid, e.g., increasing or decreasing the duplicate score, depending on the particular implementation, based on whether the duplicate is valid or invalid. As such, the duplicate score may be combined with the other scores, such as in the manner outlined in FIG. 5, to generate a weighted aggregate of the scores which is then used to compare to one or more thresholds, as in steps 545 and 550, for example.

Thus, in addition to the mechanism previously described, the illustrative embodiments further provide functionality for evaluating the validity/invalidity of duplicate medication instances in aggregate patient EMR data. The evaluation may be based on a large variety of factors that are all indicative of the likelihood, or probability, that a duplicate medication was duplicated for valid or invalid reasons. Such evaluations help to identify instances where a patient may be taking medications that the patient should not be taking, or even instances where patients are obtaining medications nefariously, such as in the case of controlled substances.

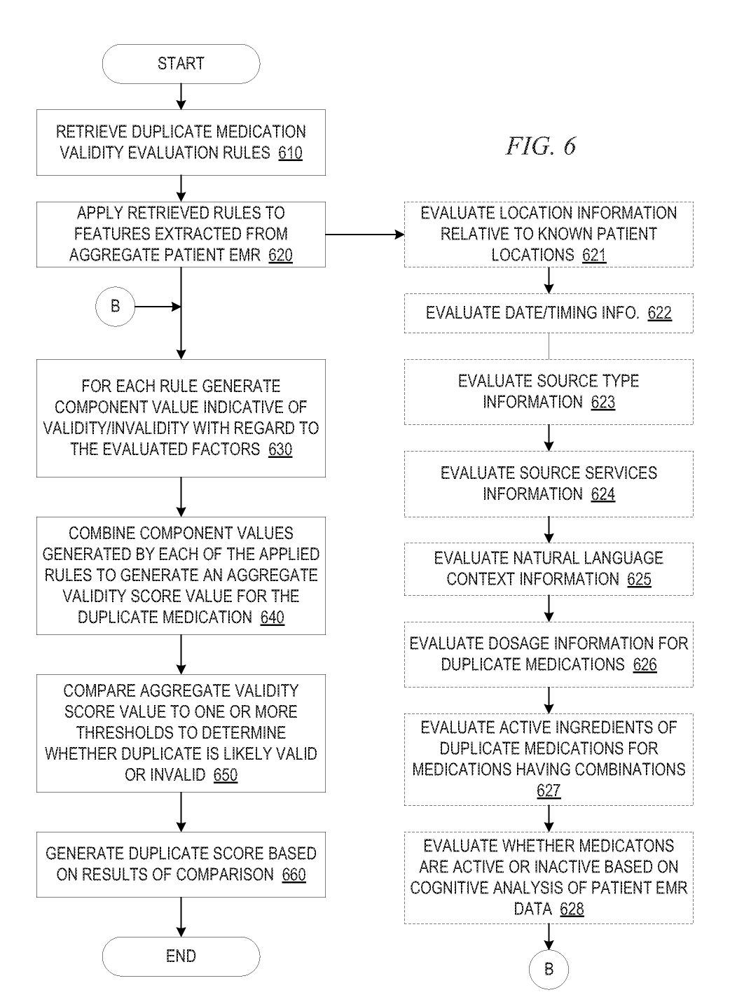

FIG. 6 is a flowchart outlining an example operation for identifying valid and/or invalid duplicate medications in a patient's medical data or information in accordance with one illustrative embodiment. The operation outlined in FIG. 6 may be implemented, for example, by the logic of a duplicate medication analysis engine, such as engine 132 in FIG. 1, which may be provided via a specially configured computing device, for example. The operation outlined in FIG. 6 assumes that a duplicate medication instance has already been found in the aggregate patient EMR data, such as part of step 525 in FIG. 5 for example, and the operation shown in FIG. 6 is to evaluate the validity/invalidity of the duplicate medication instance. Thus, it should be appreciated that the operation shown in FIG. 6 may be applied to multiple instances of duplicate medication instances separately to evaluate the validity/invalidity of each such duplicate medication instance.

As shown in FIG. 6, the operation starts by retrieving duplicate medication validity evaluation rules to be used to evaluate the validity/invalidity of the particular duplicate medication instance (step 610). As noted above, in some embodiments, the rules may be specific to particular types or classes of medications and thus, the operation of step 610 may retrieve the subset of rules that specifically is associated with the class or type of medication that matches the duplicate medication instance.

The retrieved rules are applied to features extracted from the aggregate patient EMR in association with the duplicate medication instance (step 620). As shown in FIG. 6, and previously described above, the application of such rules may involve the evaluation of a variety of different features or factors that the rules reference as well as applying weight values to these various different features or factors. For example, as shown in FIG. 6 as dashed lined boxes, these evaluations may involve evaluating location information for sources relative to known locations that are associated with the patient (step 621). These evaluations may involve evaluating date/timing information associated with the duplicate medication instances (step 622). These evaluations may involve evaluating the types of sources (step 623) and the services that the sources provide (step 624). Moreover, the evaluations may involve evaluating natural language context information extracted from the aggregate patient EMR data in association with the duplicate medication instances using natural language processing techniques (step 625). Furthermore, dosage information (step 626), active ingredient information (step 627), and indications of active/inactive medication consumption/administering by the patient (step 628) may be evaluated in order to apply the rules to the extracted features. It should be appreciated that these are all examples of evaluations with any combination, or sub-combination, of these evaluations being potentially utilized in step 620. Moreover, other evaluations not specifically shown in FIG. 6 may also be used in addition to, or in replacement of, those shown in boxes 621-628, without departing from the spirit and scope of the present invention.

Based on the application of the rules to the extracted features in step 620, for each rule, a component value is calculated or generated which is indicative of the validity/invalidity of the duplicate medication instance from the view of the particular factors evaluated by the applied rule (step 630). The component values are combined to generate an aggregate validity score value for the duplicate medication (step 640). As noted above, both in the evaluation of factors within a rule, and with the combination of component values generated from the various rules, different weight values may be applied to different factors/component values depending on the particular implementation so as to generate weighted values. The weights that are applied may be machine learned, human subject matter expert specified, or otherwise determined via an automated, semi-automated, or manual process.

The aggregated validity score value may then be compared to one or more thresholds to determine whether or not the duplicate medication instance is likely valid or invalid (step 650). Based on the determined likelihood, i.e. the probability, a duplicate score is generated indicating the probability that the duplicate medication instances are actual duplicates and the validity/invalidity of the duplicate (step 660). The operation then terminates.

As mentioned previously, as an alternative embodiment, rather than generating a duplicate score, a notification may be sent to appropriate parties in response to a determination that the duplicate medication instance is an invalid duplicate. In this alternative embodiment, if the duplicate is determined to be a valid duplicate, then the duplicate score may be generated in step 660 and the process of FIG. 5 may be followed as previously described above.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to be specifically configured to execute the operations of the method in the data processing system, comprising:
generating, by the data processing system, aggregate patient data from patient data obtained from computing devices associated with a plurality of different sources of patient data for a patient;
analyzing, by the data processing system, the aggregate patient data to identify a duplicate medication instance indicated by content of the aggregate patient data, wherein the duplicate medication instance is a first entry in the aggregate patient data obtained from patient data originating from a first source that identifies a same or similar medication as a second entry in the aggregate patient data obtained from patient data originating from a second source;
determining, by the data processing system, whether the duplicate medication instance is a valid duplicate medication instance or an invalid duplicate medication instance based on features extracted from the aggregate patient data; and
in response to a determination that the duplicate medication instance is an invalid duplicate medication instance, sending a notification to a computing device indicating invalidity of the duplicate medication instance.

2. The method of claim 1, further comprising:
in response to determining that the duplicate medication instance is an invalid medication instance, removing the invalid duplicate medication instance from a medication listing data structure associated with the aggregate patient data.

3. The method of claim 1, wherein analyzing the aggregate patient data to identify a duplicate medication instance indicated by content of the aggregate patient data comprises generating a validity score for the duplicate medication instance based on applying at least one predefined rule that weights a plurality of factors extracted from the aggregate patient data.

4. The method of claim 3, wherein a predefined rule evaluates a difference in dates or times associated with the first entry and the second entry, a difference in geographical location between a first source that is a source of the first entry, a second source that is a source of the second entry, and locations associated with the patient, and a type of services or products provided by the first source and the second source.

5. The method of claim 3, wherein the plurality of factors weighted by the at least one predefined rule comprise at least one of:
a timing factor based on time information associated with the first entry and the second entry, wherein the timing factor indicates an amount of time elapse between the first entry and the second entry;
a source factor based on source identity information associated with the first entry and the second entry, wherein the source factor indicates whether or not the first source is different than the second source;
a distance factor based on location information associated with the patient and location information associated with the first source and the second source; or a dosage factor indicating a first dosage amount associated with the first entry and a second dosage amount associated with the second entry.

6. The method of claim 5, wherein in response to the time elapse being less than a predetermined time period the at least one predefined rule scores the timing factor lower than if the time elapse were equal to or greater than the predetermined time period.

7. The method of claim 6, wherein the time elapse is correlated with an amount of a medication associated with the second entry to determine whether or not the time information associated with the first entry is prior to an expected time when the amount of medication associated with the second entry would reduce below a predetermined amount.

8. The method of claim 5, wherein in response to a distance between a first location associated with the first source, a second location associated with the second source, and a location associated with the patient, being equal to or greater than a threshold distance value, the at least one predefined rule scores the distance factor higher than if the distance were less than the threshold distance value.

9. The method of claim 1, wherein the notification is a notification to the first source of the first entry, requesting that the first source confirm removal of the duplicate medication instance from a medication listing data structure associated with the aggregate patient data, and wherein, in response to receiving an input from the first source indicating confirmation of the removal of the duplicate medication instance, the method comprises removing the duplicate medication instance from the medication listing data structure.

10. The method of claim 1, wherein the entity is a medication dispensing location, and wherein the notification is a notification instructing the entity to invalidate the duplicate medication instance in the computing system.

11. A computer program product comprising a computer readable storage medium having a computer readable program stored therein, wherein the computer readable program, when executed on a computing device, causes the computing device to be specifically configured to execute operations to:
generate aggregate patient data from patient data obtained from computing devices associated with a plurality of different sources of patient data for a patient;
analyze the aggregate patient data to identify a duplicate medication instance indicated by content of the aggregate patient data, wherein the duplicate medication instance is a first entry in the aggregate patient data obtained from patient data originating from a first source that identifies a same or similar medication as a second entry in the aggregate patient data obtained from patient data originating from a second source;
determine whether the duplicate medication instance is a valid duplicate medication instance or an invalid duplicate medication instance based on features extracted from the aggregate patient data; and
in response to a determination that the duplicate medication instance is an invalid duplicate medication instance, send a notification to a computing device indicating invalidity of the duplicate medication instance.

12. The computer program product of claim 11, wherein the computer readable program further causes the computing device to remove, in response to determining that the duplicate medication instance is an invalid medication instance, the invalid duplicate medication instance from a medication listing data structure associated with the aggregate patient data.

13. The computer program product of claim 11, wherein the computer readable program further causes the computing device to analyze the aggregate patient data to identify a duplicate medication instance indicated by content of the aggregate patient data at least by generating a validity score for the duplicate medication instance based on applying at least one predefined rule that weights a plurality of factors extracted from the aggregate patient data.

14. The computer program product of claim 13, wherein a predefined rule evaluates a difference in dates or times associated with the first entry and the second entry, a difference in geographical location between a first source that is a source of the first entry, a second source that is a source of the second entry, and locations associated with the patient, and a type of services or products provided by the first source and the second source.

15. The computer program product of claim 13, wherein the plurality of factors weighted by the at least one predefined rule comprise at least one of:
a timing factor based on time information associated with the first entry and the second entry, wherein the timing factor indicates an amount of time elapse between the first entry and the second entry;
a source factor based on source identity information associated with the first entry and the second entry, wherein the source factor indicates whether or not the first source is different than the second source;
a distance factor based on location information associated with the patient and location information associated with the first source and the second source; or a dosage factor indicating a first dosage amount associated with the first entry and a second dosage amount associated with the second entry.

16. The computer program product of claim 15, wherein in response to the time elapse being less than a predetermined time period the at least one predefined rule scores the timing factor lower than if the time elapse were equal to or greater than the predetermined time period.

17. The computer program product of claim 16, wherein the time elapse is correlated with an amount of a medication associated with the second entry to determine whether or not the time information associated with the first entry is prior to an expected time when the amount of medication associated with the second entry would reduce below a predetermined amount.

18. The computer program product of claim 15, wherein in response to a distance between a first location associated with the first source, a second location associated with the second source, and a location associated with the patient, being equal to or greater than a threshold distance value, the at least one predefined rule scores the distance factor higher than if the distance were less than the threshold distance value.

19. The computer program product of claim 11, wherein the notification is a notification to the first source of the first entry, requesting that the first source confirm removal of the duplicate medication instance from a medication listing data structure associated with the aggregate patient data, and wherein the computer readable program further causes the computing device to remove, in response to receiving an input from the first source indicating confirmation of the removal of the duplicate medication instance, the duplicate medication instance from the medication listing data structure.

20. An apparatus comprising:
a processor; and
a memory coupled to the processor, wherein the memory comprises instructions which, when executed by the processor, cause the processor to:
generate aggregate patient data from patient data obtained from computing devices associated with a plurality of different sources of patient data for a patient;
analyze the aggregate patient data to identify a duplicate medication instance indicated by content of the aggregate patient data, wherein the duplicate medication instance is a first entry in the aggregate patient data obtained from patient data originating from a first source that identifies a same or similar medication as a second entry in the aggregate patient data obtained from patient data originating from a second source;
determine whether the duplicate medication instance is a valid duplicate medication instance or an invalid duplicate medication instance based on features extracted from the aggregate patient data; and
in response to a determination that the duplicate medication instance is an invalid duplicate medication instance, send a notification to a computing device indicating invalidity of the duplicate medication instance.
